(19) United States
(12) Patent Application Publication
(10) Pub. No.: US 2026/0107313 A1
(43) Pub. Date: Apr. 16, 2026

(54) PHYSICAL RANDOM ACCESS CHANNEL OCCASION VALIDITY FOR SUB-BAND FULL DUPLEX AND PAGING MONITORING OCCASIONS

(71) Applicant: QUALCOMM Incorporated, San Diego, CA (US)

(72) Inventors: Ahmed Attia ABOTABL, San Diego, CA (US); Hung Dinh LY, San Diego, CA (US); Muhammad Sayed Khairy ABDELGHAFFAR, San Jose, CA (US)

(21) Appl. No.: 18/913,530

(22) Filed: Oct. 11, 2024

(51) Int. Cl. H04W 74/0833; H04L 5/14; H04W 68/02

(52) U.S. Cl. CPC H04W 74/0833; H04L 5/14; H04W 68/02

(57) ABSTRACT

Various aspects of the present disclosure generally relate to wireless communication. Some aspects relate to resolving an overlap between a physical random access channel (PRACH) occasion and a sub-band full duplex (SBFD) resource that includes a paging monitoring occasion or a paging early indication (PEI) monitoring occasion (MO). Some aspects more specifically relate to identifying whether a PRACH occasion has a valid status (such as for the purpose of selecting a PRACH occasion for a RACH transmission, defining a mapping of PRACH occasions to synchronization signal blocks (SSBs), or a combination thereof) based on whether the PRACH occasion overlaps an SBFD resource that includes a paging monitoring occasion or a PEI MO.

### FIELD OF THE DISCLOSURE

Aspects of the present disclosure generally relate to wireless communication and specifically relate to techniques, apparatuses, and methods associated with physical random access channel occasion validity for sub-band full duplex and paging monitoring occasions.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A user equipment (UE) may be configured with various types of occasions usable for various types of communication. For example, the UE may be configured with a set of physical random access channel (PRACH) occasions on which the UE can transmit a PRACH transmission. As another example, the UE may be configured with a set of paging monitoring occasions on which the UE may monitor for paging that is relevant to the UE. As another example, the UE may be configured with a set of paging early indication (PEI) monitoring occasions on which the UE may monitor for a PEI that indicates whether a future paging occasion will be used.

A RAT may support half-duplex communication, full-duplex communication, or both. In half-duplex communication, a wireless communication device may communicate in a single “direction” (such as an uplink direction or a downlink direction) on a given time and frequency (time/frequency) resource. In full-duplex communication, a wireless communication device may communicate in two directions (such as an uplink direction and a downlink direction) in the same time/frequency resource. Full-duplex communication may increase throughput, but may be associated with increased complexity. Sub-band full-duplex (SBFD) communication is a type of full-duplex communication in which a communication bandwidth is divided into one or more uplink sub-bands and one or more downlink sub-bands that do not overlap one another. SBFD can be supported at a UE, a network entity, or both. For example, SBFD may be supported at a network entity (such that the network entity simultaneously performs uplink communication on the one or more uplink sub-bands and downlink communication on the one or more downlink sub-bands) and not at a UE (such that the UE only performs one of uplink communication on the one or more uplink sub-bands or downlink communication on the one or more downlink sub-bands).

### SUMMARY

Certain aspects provide a method for wireless communications by an apparatus. The method includes receiving a sub-band full duplex (SBFD) configuration that indicates an SBFD resource, wherein the SBFD resource includes at least one of a paging monitoring occasion or a paging early indication monitoring occasion. The method includes receiving a physical random access channel (PRACH) configuration that indicates a set of PRACH occasions, wherein one or more PRACH occasions of the set of PRACH occasions occur in the SBFD resource. The method includes performing a PRACH transmission on a PRACH occasion, of the set of PRACH occasions, that is associated with a valid status, wherein the valid status is associated with one or more of: whether the PRACH occasion is overlapped by the SBFD resource and the SBFD resource includes the paging monitoring occasion, or whether the PRACH occasion is overlapped by the SBFD resource and the SBFD resource includes the paging early indication monitoring occasion.

Certain aspects provide a method for wireless communications by an apparatus. The method includes sending a SBFD configuration that indicates an SBFD resource, wherein the SBFD resource includes at least one of a paging monitoring occasion or a paging early indication monitoring occasion. The method includes sending a PRACH configuration that indicates a set of PRACH occasions, wherein one or more PRACH occasions of the set of PRACH occasions occur in the SBFD resource. The method includes receiving a PRACH transmission on a PRACH occasion, of the set of PRACH occasions, that is associated with a valid status, wherein the valid status is associated with one or more of: whether the PRACH occasion is overlapped by the SBFD resource including the paging monitoring occasion, or whether the PRACH occasion is overlapped by the SBFD resource including the paging early indication monitoring occasion.

Certain aspects provide an apparatus configured for wireless communication, comprising a processing system comprising one or more processors and one or more memories coupled to the one or more processors. The processing system is configured to cause the apparatus to receive an SBFD configuration that indicates an SBFD resource, wherein the SBFD resource includes at least one of a paging monitoring occasion or a paging early indication monitoring occasion. The processing system is configured to cause the apparatus to receive a PRACH configuration that indicates a set of PRACH occasions, wherein one or more PRACH occasions of the set of PRACH occasions occur in the SBFD resource. The processing system is configured to cause the apparatus to perform a PRACH transmission on a PRACH occasion, of the set of PRACH occasions, that is associated with a valid status, wherein the valid status is associated with one or more of: whether the PRACH occasion is overlapped by the SBFD resource and the SBFD resource includes the paging monitoring occasion, or whether the PRACH occasion is overlapped by the SBFD resource and the SBFD resource includes the paging early indication monitoring occasion.

Certain aspects provide an apparatus configured for wireless communication, comprising a processing system comprising one or more processors and one or more memories coupled to the one or more processors. The processing system is configured to cause the apparatus to send an SBFD configuration that indicates an SBFD resource, wherein the SBFD resource includes at least one of a paging monitoring occasion or a paging early indication monitoring occasion. The processing system is configured to cause the apparatus to send a PRACH configuration that indicates a set of PRACH occasions, wherein one or more PRACH occasions of the set of PRACH occasions occur in the SBFD resource. The processing system is configured to cause the apparatus to receive a PRACH transmission on a PRACH occasion, of the set of PRACH occasions, that is associated with a valid status, wherein the valid status is associated with one or more of whether the PRACH occasion is overlapped by the SBFD resource including the paging monitoring occasion, or whether the PRACH occasion is overlapped by the SBFD resource including the paging early indication monitoring occasion.

Certain aspects provide one or more non-transitory computer-readable media comprising executable instructions that, when executed by one or more processors of an apparatus, cause the apparatus to perform operations. The operations may comprise receiving an SBFD configuration that indicates an SBFD resource, wherein the SBFD resource includes at least one of a paging monitoring occasion or a paging early indication monitoring occasion. The operations may comprise receiving a PRACH configuration that indicates a set of PRACH occasions, wherein one or more PRACH occasions of the set of PRACH occasions occur in the SBFD resource. The operations may comprise performing a PRACH transmission on a PRACH occasion, of the set of PRACH occasions, that is associated with a valid status, wherein the valid status is associated with one or more of: whether the PRACH occasion is overlapped by the SBFD resource and the SBFD resource includes the paging monitoring occasion, or whether the PRACH occasion is overlapped by the SBFD resource and the SBFD resource includes the paging early indication monitoring occasion.

Certain aspects provide one or more non-transitory computer-readable media comprising executable instructions that, when executed by one or more processors of an apparatus, cause the apparatus to perform operations. The operations may comprise sending an SBFD configuration that indicates an SBFD resource, wherein the SBFD resource includes at least one of a paging monitoring occasion or a paging early indication monitoring occasion. The operations may comprise sending a PRACH configuration that indicates a set of PRACH occasions, wherein one or more PRACH occasions of the set of PRACH occasions occur in the SBFD resource. The operations may comprise receiving a PRACH transmission on a PRACH occasion, of the set of PRACH occasions, that is associated with a valid status, wherein the valid status is associated with one or more of: whether the PRACH occasion is overlapped by the SBFD resource including the paging monitoring occasion, or whether the PRACH occasion is overlapped by the SBFD resource including the paging early indication monitoring occasion.

Certain aspects provide an apparatus configured for wireless communication. The apparatus may comprise means for receiving an SBFD configuration that indicates an SBFD resource, wherein the SBFD resource includes at least one of a paging monitoring occasion or a paging early indication monitoring occasion. The apparatus may comprise means for receiving a PRACH configuration that indicates a set of PRACH occasions, wherein one or more PRACH occasions of the set of PRACH occasions occur in the SBFD resource. The apparatus may comprise means for performing a PRACH transmission on a PRACH occasion, of the set of PRACH occasions, that is associated with a valid status, wherein the valid status is associated with one or more of: whether the PRACH occasion is overlapped by the SBFD resource and the SBFD resource includes the paging monitoring occasion, or whether the PRACH occasion is overlapped by the SBFD resource and the SBFD resource includes the paging early indication monitoring occasion.

Certain aspects provide an apparatus for wireless communication. The apparatus may comprise means for sending an SBFD configuration that indicates an SBFD resource, wherein the SBFD resource includes at least one of a paging monitoring occasion or a paging early indication monitoring occasion. The apparatus may comprise means for sending a PRACH configuration that indicates a set of PRACH occasions, wherein one or more PRACH occasions of the set of PRACH occasions occur in the SBFD resource. The apparatus may comprise means for receiving a PRACH transmission on a PRACH occasion, of the set of PRACH occasions, that is associated with a valid status, wherein the valid status is associated with one or more of: whether the PRACH occasion is overlapped by the SBFD resource including the paging monitoring occasion, or whether the PRACH occasion is overlapped by the SBFD resource including the paging early indication monitoring occasion.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network entity architecture.

FIG. 3 depicts aspects of network entities and a user equipment (UE).

FIGS. 4A and 4B depict process flow diagrams of example random access channel (RACH) procedures.

FIG. 5 illustrates an example mapping of synchronization signal blocks (SSBs) to physical random access channel (PRACH) occasions.

FIG. 6 is a diagram illustrating examples of full-duplex communication in a wireless network.

FIG. 7 is a diagram illustrating an example of random access in sub-band full duplex (SBFD) symbols.

FIG. 8 is a diagram illustrating a first example of a validity status for a PRACH occasion that is overlapped by an SBFD resource that includes a paging monitoring occasion (MO).

FIG. 9 is a diagram illustrating a second example of a validity status for a PRACH occasion that is overlapped by an SBFD resource that includes a paging MO.

FIG. 10 is a diagram illustrating a third example of a validity status for a PRACH occasion that is overlapped by an SBFD resource that includes a paging MO.

FIG. 11 is a diagram illustrating a fourth example of a validity status for a PRACH occasion that is overlapped by an SBFD resource that includes a paging MO.

FIG. 12 is a diagram illustrating examples of validity statuses for a PRACH occasion that is overlapped by an SBFD resource that includes a paging early indication (PEI) MO.

FIG. 13 is a diagram illustrating an example of signaling for determination of a validity status for a PRACH occasion that is overlapped by an SBFD resource that includes a PEI MO or a paging MO.

FIG. 14 shows a process for wireless communications by an apparatus.

FIG. 15 shows a process for wireless communications by an apparatus.

FIG. 16 depicts aspects of an example communications device configured for wireless communications.

FIG. 17 depicts aspects of an example communications device configured for wireless communications.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Sub-band full-duplex (SBFD) communication is a type of full-duplex communication in which a communicating bandwidth is divided into one or more uplink sub-bands and one or more downlink sub-bands that do not overlap one another in the frequency domain. SBFD can be supported at a user equipment (UE), a network entity (such as a gNB, a distributed unit, or a radio unit), or both. For example, SBFD may be supported at a network entity (such that the network entity simultaneously performs uplink communication on the one or more uplink sub-bands and downlink communication on the one or more downlink sub-bands) and not at a UE (such that the UE only performs one of uplink communication on the one or more uplink sub-bands or downlink communication on the one or more downlink sub-bands at a given time). In some examples, such a UE may be aware of an SBFD configuration of a resource, and may use only part of the resource for communication by the UE. This is referred to as an SBFD-aware UE. In some other examples, such a UE may not be aware of the SBFD configuration of the resource. For example, such a UE may not support SBFD-related signaling, and may treat the resource as a half-duplex resource. A resource that is configured for SBFD communication may be referred to as an SBFD resource, and may include, for example, a slot or a symbol.

A UE of a wireless communication network may perform a random access channel (RACH) procedure for various purposes, such as initial access, random-access-based handover, or connection reestablishment. A RACH procedure involves the transmission of a RACH preamble on a time-frequency resource configured for a device to perform a RACH procedure, referred to herein as a physical RACH (PRACH) occasion and sometimes referred to as a RACH occasion. A UE may be configured with a number of PRACH occasions, and different PRACH occasions may be associated with different parameters, such as different synchronization signal blocks. A RACH procedure may be performed using a PRACH. In some contexts, “RACH” and “PRACH”may be used interchangeably.

Paging is a mechanism for efficiently notifying a UE of incoming calls, data, or system information updates when the UE is in an idle or inactive mode. A UE may monitor for a paging message (such as a paging downlink control information (DCI) message) on a paging monitoring occasion (MO). A paging MO is a specific time interval during which a UE wakes up from a low-power state to check for paging messages from the network. These paging MOs are configured based on various parameters, including the UE's identity, the number of paging frames per paging cycle, and the number of paging occasions per paging frame. By synchronizing these paging MOs between the network and the UE, power consumption is reduced as the UE only needs to monitor for paging messages during these predetermined intervals.

Paging early indication (PEI) is an enhancement to the paging mechanism. PEI is designed to further improve UE power efficiency and reduce latency. A PEI message provides a preliminary notification to the UE about an upcoming paging message, allowing the UE to prepare for the full paging message reception or skip monitoring of a paging MO if no paging message is upcoming. By implementing PEI, UEs can make more informed decisions about whether to fully wake up and process the subsequent paging message, potentially leading to substantial power savings and improved responsiveness. A UE may monitor for a PEI message in a configured resource referred to as a PEI MO. It may be optional for a UE to monitor a PEI MO.

PRACH occasions, paging MOs, and PEI MOs may generally be semi-statically configured, such as via radio resource control (RRC) signaling or system information broadcast. In some examples, one or more of these occasions may be configured for a large number of UEs. Furthermore, in some cases, PRACH occasions may be subject to PRACH adaptation, in which a number of PRACH occasions configured for a UE (or another parameter of the PRACH occasions) may be changed after initial configuration of the number of PRACH occasions.

These configurations and/or updates may lead to a situation where a PRACH occasion occurs in an SBFD resource that also includes a paging MO or PEI MO. This may be problematic in a case where a UE only performs half-duplex communication in an SBFD resource, since a PRACH occasion is associated with uplink transmission and a PEI MO or paging MO is associated with downlink communication. For example, the UE may be capable of performing only one of a RACH transmission or a monitoring operation (such as a paging monitoring operation or a PEI monitoring operation) in the SBFD resource, and may not be expected to perform both the RACH transmission and the monitoring operation in the SBFD resource. Furthermore, it may be impractical for a network entity to configure each UE to avoid the overlap of PRACH occasions, paging MOs and/or PEI MOs, and SBFD resources, given the number of UEs that can be configured by a network entity and flexibility and adaptability of these configurations. Thus, failure to account for overlaps between PRACH occasions and paging MOs or PEI MOs in an SBFD resource may lead to inefficient resource utilization and failure of communications at the UE.

Various aspects generally relate to resolving an overlap between a PRACH occasion and an SBFD resource that includes a paging MO or a PEI MO. Some aspects more specifically relate to identifying whether a PRACH occasion has a valid status (such as for purposes of selecting a PRACH occasion for a RACH transmission, defining a mapping of PRACH occasions to synchronization signal blocks (SSBs), or a combination thereof) based on whether the PRACH occasion overlaps an SBFD resource that includes a paging MO or a PEI MO.

For example, a UE may consider a PRACH occasion to be invalid if the PRACH occasion overlaps an SBFD resource (such as an SBFD slot) that includes a paging MO. As another example, a UE may consider a PRACH occasion to be valid if the PRACH occasion overlaps an SBFD resource that includes a paging MO only if the paging MO is separated from the PRACH occasion, in time, by a gap of a threshold length. As another example, a UE may consider a PRACH occasion to be valid for purposes of SSB mapping if the PRACH occasion overlaps such an SBFD resource, but may not use the PRACH occasion for transmission of a PRACH transmission. As another example, the UE may consider a PRACH occasion to be valid, and may use the PRACH occasion, if the PRACH occasion overlaps an SBFD resource including a paging MO that will be unused (according, for example, to a PEI). As another example, the UE may consider a PRACH occasion to be invalid if the PRACH occasion overlaps an SBFD resource that includes a PEI MO. As another example, the UE may consider a PRACH occasion to be valid if the PRACH occasion overlaps an SBFD resource that includes a PEI MO, and may select whether to transmit on the PRACH occasion or monitor the PEI MO.

Particular aspects of the subject matter described in this disclosure can be implemented to realize one or more of the following potential advantages. In some examples, by defining a valid status of a PRACH occasion based on whether the PRACH occasion overlaps an SBFD resource that includes a paging MO or PEI MO, the described techniques can be used to address uncertainty regarding whether an uplink operation or a downlink operation should be performed in the SBFD resource, improving compatibility with UEs that do not support SBFD communication or signaling. By defining a PRACH occasion to be invalid if the PRACH occasion overlaps an SBFD resource that includes a paging MO, paging reception is prioritized, thereby improving reliability of paging. By defining a PRACH occasion to be valid if the PRACH occasion overlaps an SBFD resource that includes a paging MO only if the paging MO is separated from the PRACH occasion, in time, by a gap of a threshold length, a UE is given time to switch from an uplink configuration to a downlink configuration or vice versa, enabling both the PRACH occasion and the paging MO to be used. By defining a PRACH occasion to be valid only for purposes of SSB mapping if the PRACH occasion overlaps an SBFD resource, latency associated with RACH procedures is reduced. By defining a PRACH occasion to be valid and usable if the PRACH occasion overlaps an SBFD resource including a paging MO that will be unused (according, for example, to a PEI), the impact of RACH on paging is reduced and resource efficiency is improved. By defining a PRACH occasion to be invalid if the PRACH occasion overlaps an SBFD resource that includes a PEI MO, reliability of PEI transmission is improved. By defining a PRACH occasion to be valid if the PRACH occasion overlaps an SBFD resource that includes a PEI MO, and allowing selection of whether to transmit on the PRACH occasion or monitor the PEI MO, the UE is given flexibility on whether to use a PRACH occasion or monitor for a PEI, thereby improving efficiency at the UE.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

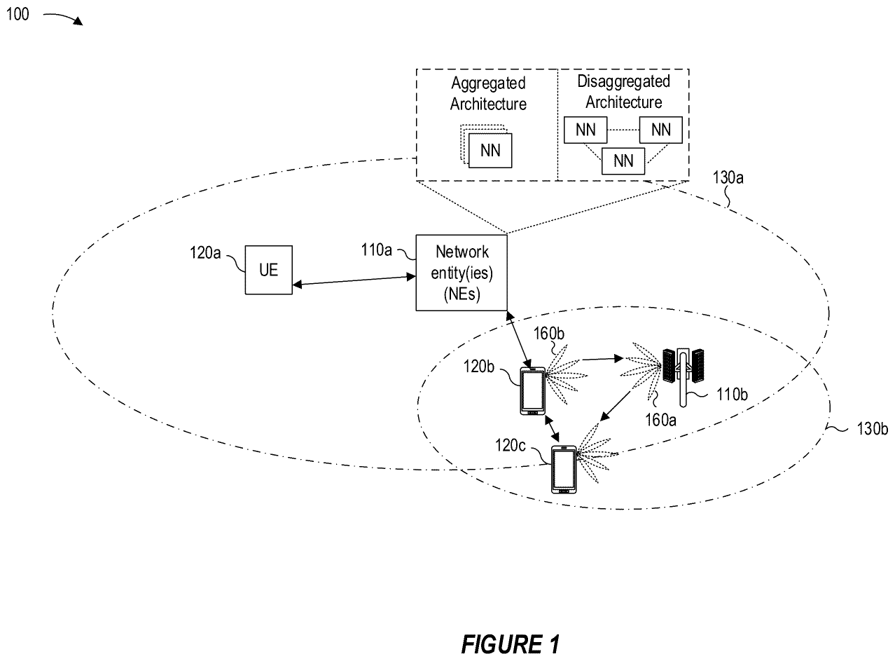

FIG. 1 is a diagram illustrating an example of a wireless communication network 100. The wireless communication network 100 may be or may include elements of a 5G (or NR) network or a 6G network, among other examples. The wireless communication network 100 may include multiple network entities 110. For example, in FIG. 1, the wireless communication network 100 includes a network entity (NE) 110a and a network entity 110b. The network entities 110 may support communications with multiple UEs 120. For example, in FIG. 1, the network entities 110 support communication with a UE 120a, a UE 120b, and a UE 120c. In some examples, a UE 120 may also communicate with other UEs 120 and a network entity 110 may communicate with a core network and with other network entities 110.

The network entities 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network entity 110 may be, may include, or may also be referred to as an NR network entity, a 5G network entity, a 6G network entity, a Node B, a gNB, an access point (AP), a transmission reception point (TRP), a network entity, a network element, a network equipment, and/or another type of device, component, or system included in a RAN. In various deployments, a network entity 110 may be implemented as a single physical node (for example, a single physical structure) or may be implemented as two or more physical nodes (for example, two or more distinct physical structures). For example, a network entity 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network entity 110 may be an aggregated network entity having an aggregated architecture, meaning that the network entity 110 may implement a full radio protocol stack that is physically and logically integrated within a single physical structure in the wireless communication network 100. For example, an aggregated network entity 110 may consist of a single standalone base station or a single TRP that operates with a full radio protocol stack to enable or facilitate communication between a UE 120 and a core network of the wireless communication network 100.

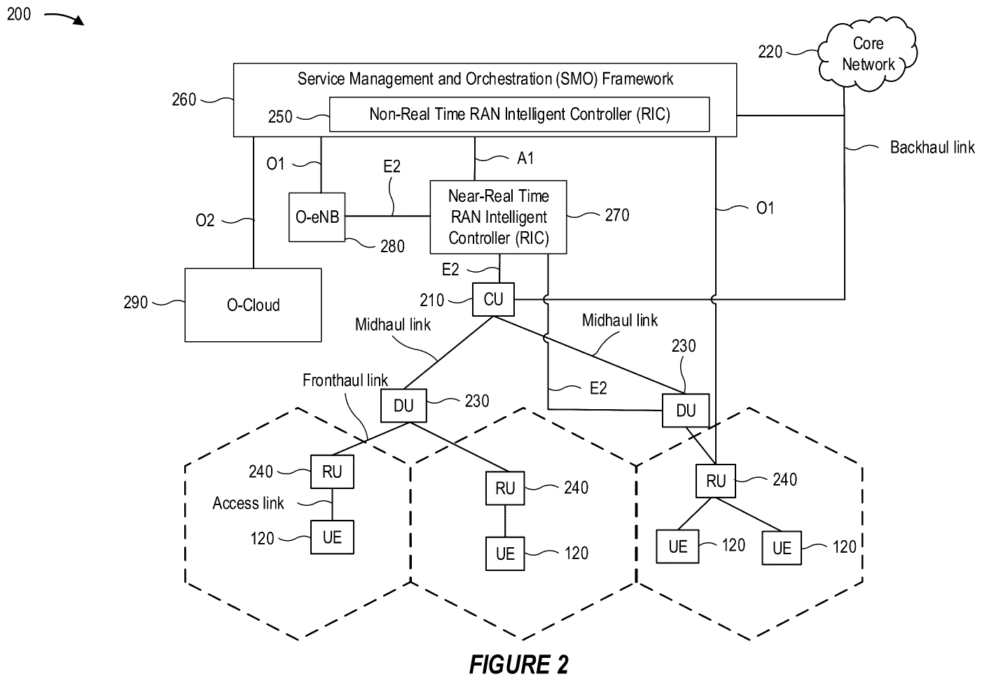

Alternatively, and as also shown, a network entity 110 may be a disaggregated network entity (sometimes referred to as a disaggregated base station), having a disaggregated architecture, meaning that the network entity 110 may operate with a radio protocol stack that is physically distributed and/or logically distributed among two or more nodes in the same geographic location or in different geographic locations. An example disaggregated network entity architecture is described in more detail below with reference to FIG. 2. In some deployments, disaggregated network entities 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network entities 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as an FFT, an IFFT, beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network entity 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network entities 110 (for example, a base station, an RU, or a TRP) may provide communication coverage for a particular geographic area. The term “cell” can refer to a coverage area of a network entity 110 or to a network entity 110 itself, depending on the context in which the term is used. A network entity 110 may support one or more cells (for example, each cell may support communication within an angular (for example, 60 degree) range around the network entity). In some examples, a network entity 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network entity 110 (for example, a train, a satellite, an unmanned aerial vehicle, or an NTN network entity).

The wireless communication network 100 may be a heterogeneous network that includes network entities 110 of different types, such as macro network entities, pico network entities, femto network entities, relay network entities, aggregated network entities, and/or disaggregated network entities, among other examples. Various different types of network entities 110 may generally transmit at different power levels, serve different coverage areas (for example, a cell 130a and a cell 130b), and/or have different impacts on interference in the wireless communication network 100 than other types of network entities 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network entity, and/or any other suitable device or function that may communicate via a wireless medium.

In some examples, a network entity 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network entity 110 to a UE 120, and “uplink” (or “UL”) refers to a communication direction from a UE 120 to a network entity 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

In some examples, a UE 120 and a network entity 110 may perform MIMO communication “MIMO” generally refers to transmitting or receiving multiple signals (such as multiple layers or multiple data streams) simultaneously over the same time and frequency resources. MIMO techniques generally exploit multipath propagation. A network entity 110 or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network entity 110b may generate one or more beams 160a and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network entity 110 and/or at the UE 120, such as in a network implementing mmWave technology. Massive MIMO may improve communication reliability by enabling a network entity 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

FIG. 2 is a diagram illustrating an example disaggregated network entity architecture 200. One or more components of the example disaggregated network entity architecture 200 may be, may include, or may be included in one or more network entities (such one or more network entities 110). The disaggregated network entity architecture 200 may include a CU 210 that can communicate directly with a core network 220 via a backhaul link, or that can communicate indirectly with the core network 220 via one or more disaggregated control units, such as a Non-RT RAN intelligent controller (RIC) 250 associated with a Service Management and Orchestration (SMO) Framework 260 and/or a Near-RT RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network entity architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, artificial intelligence or machine learning (AI/ML) workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

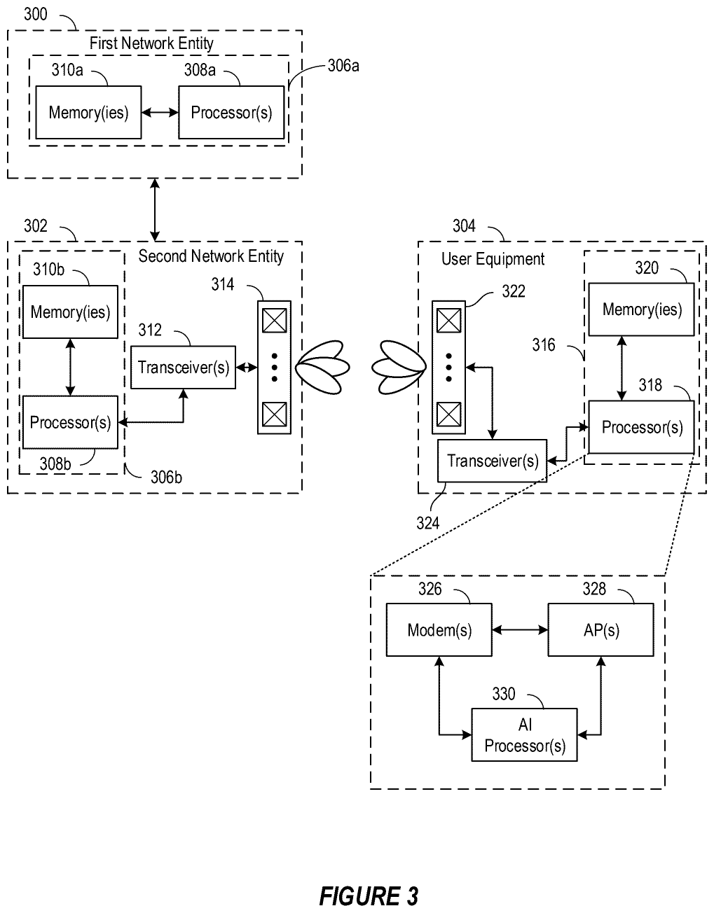

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (for example, network entity 110). For example, first network entity 300 and second network entity 302 may be co-located. In some other examples, first network entity 300 may be implemented separately from second network entity 302. For example, first network entity 300 may be implemented as a function (for example, one or more processes) running on a server, such as in a cloud (for example, a public or private cloud). As another example, first network entity 300 may be implemented as a virtual computing instance (for example, virtual machine or container) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (for example, radio, air interface) communication with other devices such as UE 304. The one or more transceivers 312 may include one or more radio frequency (RF) components, such as an RF transceiver, a front-end module (for example, an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3. The term “antenna module” may refer to circuitry including one or more antennas as well as one or more other components (such as filters, amplifiers, or processors) associated with integrating the antenna module into a wireless communication device such as the network entity 300 or 302 or the UE 304.

UE 304 may be an example of UE 120. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (for example, via modulation) and/or converts the waveform of a received signal into information (for example, via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (for example, for transmissions) or a data sink (for example, for receptions).

The one or more transceivers 324 may perform processing related to implementing physical layer (for example, radio, air interface) communication with other devices such as other UEs 304 or second network entity 302. The one or more transceivers 324 may include one or more RF components, such as an RF transceiver, a front-end module (for example, an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (for example, a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (for example, a transmit processor) may process (for example, encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (for example, a TX MIMO processor) may perform spatial processing (for example, precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (for example, convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (for example, filter, amplify, downconvert, and digitize) the received signals to obtain input samples. The one or more transceivers 324 and/or the processing system 316 may further process the input samples to obtain received symbols.

The processing system 316 (for example, modem 326, an RX MIMO detector) may obtain the received symbols, perform MIMO detection on the received symbols if applicable, and provide detected symbols. The processing system 316 (for example, a modem 326, a receive processor) may process (for example, de-interleave and decode) the detected symbols. The processing system 316 may provide decoded data for the UE 304 (for example, to an AP 328) and/or decoded control information (for example, to a controller/processor of the processing system 316).

For an example uplink transmission or a sidelink transmission from UE 304, the processing system 316 (for example, modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (for example, a modem 326, the transmit processor) may also generate reference symbols for a reference signal (for example, for a sounding reference signal (SRS), a demodulation reference signal, a phase tracking reference signal, or the like). In some examples, the symbols and/or reference signals may be precoded by the processing system 316 (for example, modem 326, a TX MIMO processor), further processed by the one or more transceivers 324 (for example, for single carrier frequency division multiplexing (SC-FDM)), and transmitted to second network entity 302.

At second network entity 302, the uplink signals from UE 304 may be received by the one or more antennas 314, conditioned by the one or more transceivers 312 (for example, filtered, amplified, downconverted, and digitized), detected (for example, by the processing system 306b such as a modem and/or an RX MIMO detector), and further processed by the processing system 306b (for example, a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304, may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). Some aspects and techniques as described herein may be implemented, at least in part, using an AI program (for example, referred to herein as an “AI/ML model”), such as a program that includes a machine learning (ML) model and/or an artificial neural network (ANN) model. The AI/ML model may be deployed at a device (for example, a network entity 300 or 302, a UE 304, an AI/ML server). For example, the AI/ML model may be deployed at a UE 304 (for example, the processing system 316), a network entity 110 (for example, the processing system 306), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 304 and a second portion of the AI/ML model may be deployed at a network entity 300 or 302). In other examples, a first AI/ML model may be deployed at a UE 304 and a second AI/ML model may be deployed at a network entity 300 or 302. The AI/ML model(s) may be configured to enhance various aspects of wireless communication. For example, the AI/ML model(s) may be trained to identify patterns or relationships in data corresponding to the wireless communication, a device, and/or an air interface, among other examples. The AI/ML model(s) may support operational decisions relating to one or more aspects associated with wireless communications devices, networks, or services.

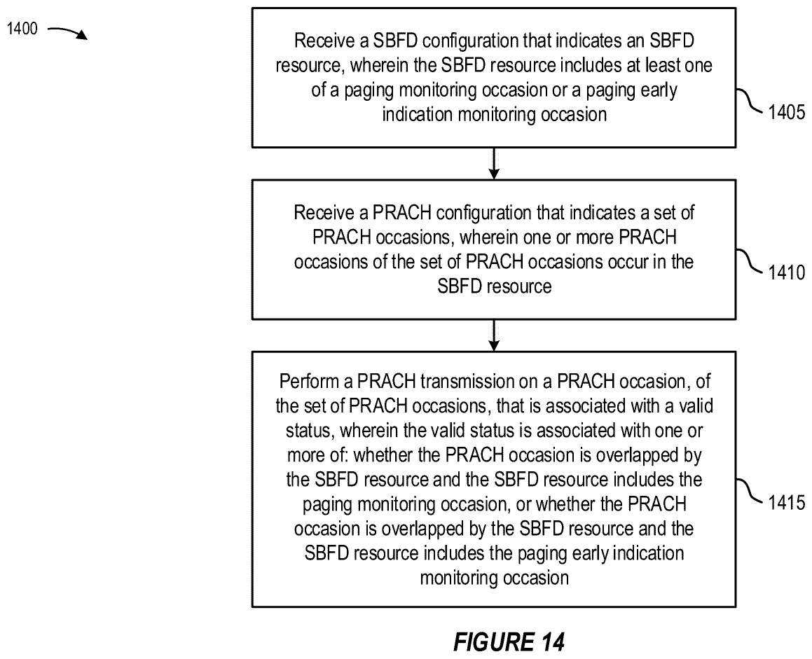

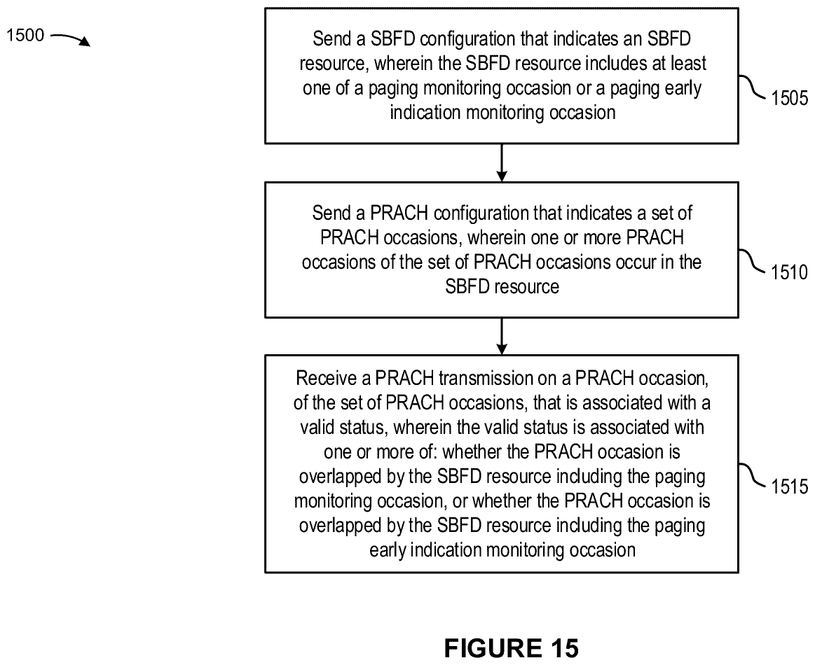

The network entity 110, the UE 120, the CU 210, the DU 230, the RU 240, the network entity 300 or 302, the processing system 306, the UE 304, the processing system 316, or any other component(s) of FIGS. 1, 2, and/or 3 may implement one or more techniques or perform one or more operations associated with validity determination for a PRACH occasion in an SBFD resource, as described in more detail elsewhere herein. For example, the network entity 110, network entity 300, or network entity 302 (collectively, “network entity 110/300/302”), the UE 120 or UE 304 (collectively, “UE 120/304”), the CU 210, the DU 230, the RU 240, the processing system 306, or the processing system 316 may perform or direct operations of, for example, process 1400 of FIG. 14, process 1500 of FIG. 15, or other processes as described herein (alone or in conjunction with one or more other processors). Memory of the network entity 110/300/302 may store data and program code (or instructions) for the network entity 110/300/302, the CU 210, the DU 230, or the RU 240. In some examples, the memory of the network entity 110/300/302 may store data relating to a UE 120/304, such as RRC state information or a UE context. Memory of the UE 120/304 may store data and program code (or instructions) for the UE 120/304, such as context information. In some examples, the memory of the UE 120/304 or the memory of the network entity 110/300/302 may include a non-transitory computer-readable medium storing a set of instructions for wireless communication. For example, the set of instructions, when executed by one or more processors (for example, the one or more processors 308 or the one or more processors 318) of the network entity 110/300/302, the UE 120/304, the CU 210, the DU 230, or the RU 240, may cause the one or more processors to perform process 1400 of FIG. 14, process 1500 of FIG. 15, or other processes as described herein. In some examples, executing instructions may include running the instructions, converting the instructions, compiling the instructions, and/or interpreting the instructions, among other examples.

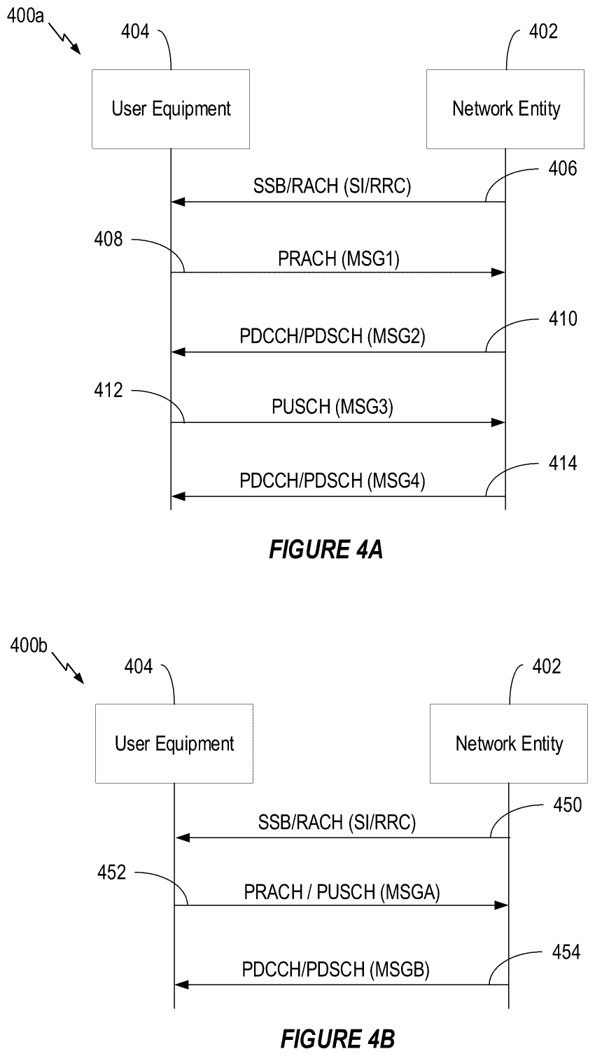

FIG. 4A depicts a process flow diagram of an example four-step RACH procedure 400a performed between a UE 404 and a network entity 402. In some aspects, the UE 404 is the UE 120 depicted and described with respect to FIG. 1 or the UE 304 depicted and described with respect to FIG. 3. In some aspects, the network entity 402 is the network entity 110 depicted and described with respect to FIG. 1, the network entity 300 or 302 depicted and described with respect to FIG. 3, or a disaggregated base station depicted and described with respect to FIG. 2.

The RACH procedure 400a may optionally begin at 406, where the network entity 402 broadcasts and the UE 404 receives a random access configuration. The random access configuration may be referred to herein as a PRACH configuration. The network entity 402 may broadcast the random access configuration, for example, in system information (SI) via an SSB, or via an RRC message. The random access configuration may indicate or include one or more parameters for random access communications, such as defining the RACH, the total number of random access preambles (for example, preamble sequences) available for random access, power ramping parameters, and/or a response window size.

At 408, the UE 404 sends a first message (MSG1) to the network entity 402 on a PRACH. In some cases, a PRACH may be referred to as a RACH. In certain aspects, MSG1 may indicate or include a RACH preamble. The RACH preamble may be or include a preamble sequence (for example, a Zadoff Chu sequence). For contention-based random access, the preamble sequence may be randomly selected among a set of preamble sequences (for example, up to 64 sequences, in some cases). The preamble sequence may be used to identify the UE 404 for scheduling communications (for example, MSG2 and MSG3) with the network entity. In certain aspects, terms such as “RACH preamble,” “random access preamble,” “preamble,” “preamble sequence,” “sequence,”and the like may be used interchangeably.

At 410, the network entity 402 may respond with a random access response (RAR) message (MSG2). For example, the network entity 402 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (for example, indicating one or more time-frequency resources for an uplink transmission), cell radio network temporary identifier (C-RNTI), and/or a backoff parameter value. The RAPID may correspond to the preamble sequence and indicate that the RAR is for the UE 404 that transmitted MSG1 at 406. The backoff parameter value may be used to determine a PRACH occasion for sending a subsequent RACH transmission (for example, a preamble transmission). A PRACH occasion may correspond to one or more time-frequency resources available for transmitting a preamble in a RACH.

At 412, in response to MSG2, the UE 404 transmits a third message (MSG3) to the network entity 402 on the PUSCH. In some aspects, MSG3 may include an RRC connection request, a tracking area update (for UE mobility), and/or a scheduling request (for an UL transmission). As an example, MSG3 is communicated in the time-frequency resource(s) indicated in the UL grant of the RAR.

At 414, the network entity 402 may send a contention resolution message (MSG4) in response to MSG3. The network entity 402 may send a downlink scheduling command (for example, DCI), which is addressed to a specific UE identity associated with the UE 404, via the PDCCH. The network entity 402 may send a UE contention resolution identity (for example, in a medium access control element) via the PDSCH according to the downlink scheduling command. In certain cases, multiple UEs may send the same preamble in the same PRACH occasion. Because the network entity 402 may not be able to identify which UE sent which preamble, the network entity 402 may reply with a single RAR associated with the preamble. The MSG3 may include or indicate a specific UE identity associated with the UE 404, such as a radio network temporary identifier (RNTI) or a temporary mobile subscriber identity (TMSI). The network entity 402 may decode MSG3 and determine the UE identity associated with at least one of the UEs (for example, UE 404). MSG4 may be addressed to the UE identity (for example the RNTI or an RNTI based on the TMSI) associated with the MSG3 that the network entity was able to successfully decode. For example, the MSG4 may be scrambled by the RNTI associated with the MSG3. If the UE 404 obtains the same identity sent in MSG3, the UE 404 concludes that the random access procedure succeeded. In some cases, if the UE 404 is unable to obtain or decode MSG3 and/or MSG4, the UE 404 may repeat the RACH procedure, such as the four-step RACH procedure 400a.

In some cases, to reduce the latency associated with random access, a two-step RACH procedure may be used. The two-step RACH procedure may effectively consolidate the four messages of the four-step RACH procedure into two messages.

FIG. 4B depicts a process flow diagram of an example two-step RACH procedure 400b performed between the UE 404 and the network entity 402.

The procedure 400b may optionally begin at 450, where the network entity 402 broadcasts and the UE 404 receives a random access configuration, for example in system information within an SSB, or in an RRC message.

At 452, the UE 404 sends a first message (MSGA) to the network entity 402, which may effectively combine MSG1 and MSG3 described above with respect to FIG. 4A. In some aspects, MSGA includes a RACH preamble for random access and a payload. For example, the payload may include a UE-ID and other signaling information, such as a buffer status report or scheduling request. The RACH preamble of MSGA may be transmitted over the PRACH, and the payload of MSGA may be transmitted over the PUSCH, for example.

At 454, the network entity 402 may send a random access response message (MSGB), which may effectively combine MSG2 and MSG4 described above, via the PDCCH and PDSCH. For example, MSGB may include a RAPID, a timing advance, a backoff parameter value, a contention resolution message, an uplink and/or downlink grant, and a transmit power control command.

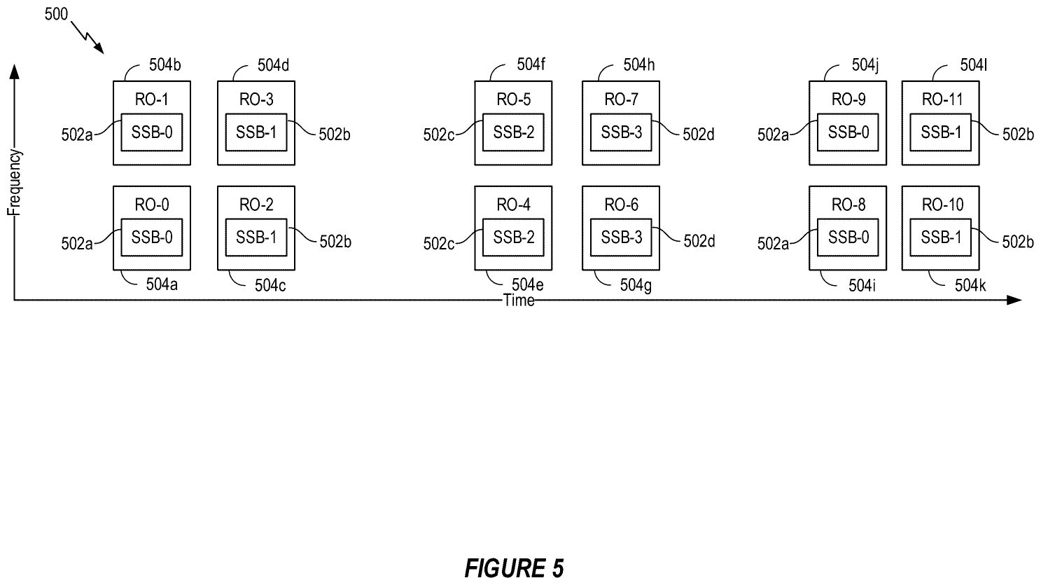

FIG. 5 illustrates an example mapping 500 of SSBs to PRACH occasions. The example mapping 500 may be performed based on a set of parameters. In certain aspects, the set of parameters may indicate an SSB to PRACH occasion mapping (sometimes referred to as an SSB-to-RO mapping or an SSB mapping). For example, the set of parameters may include or indicate a random access configuration index (for example, prach-ConfigurationIndex) that indicates a specific row of parameters in one or more look-up tables of multiple SSB to PRACH occasion mappings, where each row of parameters may indicate a different SSB to PRACH occasion mapping.

In mapping 500, there are a total of four SSBs 502a-d communicated by a network entity, and the FDM number is set to two, which allocates two FDM PRACH occasions in a time instance of a single PRACH occasion. The second set of parameters are configured to allow certain PRACH occasions associated with the second set of parameters to overlap in time and frequency resources with a subset of the PRACH occasions associated with the first set of parameters.

The mapping 500 has a total of twelve PRACH occasions 504a-l. The mapping 500 maps the first SSB 502a to the first PRACH occasion 504a and the second PRACH occasion 504b. The second SSB 502b is mapped to the third PRACH occasion 504c and the fourth PRACH occasion 504d, and so on for the subsequent SSBs 502c, 502d and the PRACH occasions 504e-l.

In some examples, SSBs may only be mapped to valid PRACH occasions. A valid PRACH occasion is a PRACH occasion having a valid status. Examples of definitions of valid statuses for PRACH occasions are provided below. According to aspects described herein, a determination of a valid status for a PRACH occasion may be based on whether the PRACH occasion overlaps an SBFD resource that includes a paging MO or a PEI MO.

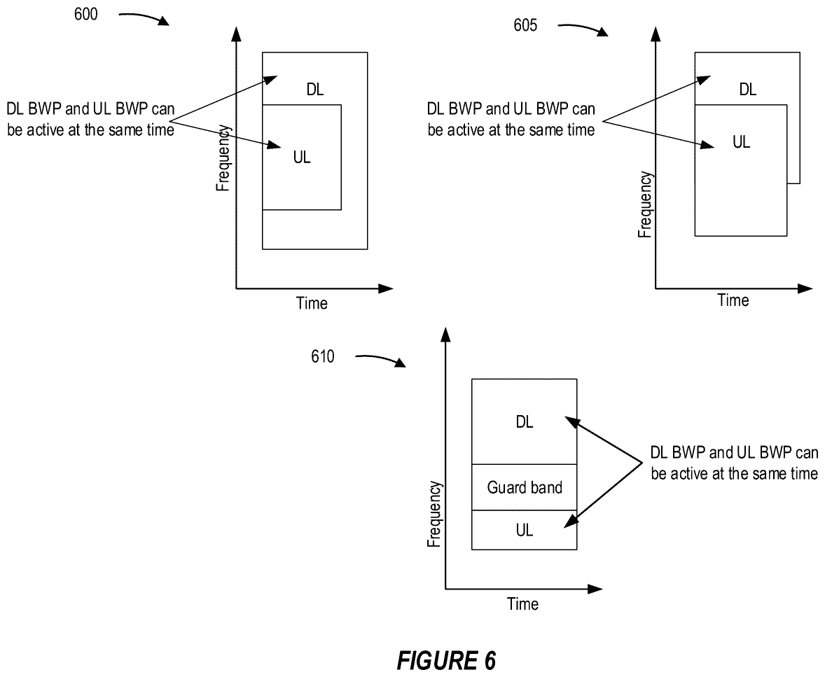

FIG. 6 is a diagram illustrating examples 600, 605, and 610 of full-duplex communication in a wireless network such as wireless communication network 100. “FD communication” in a wireless network refers to simultaneous bi-directional communication between devices in the wireless network. For example, a UE operating in a full-duplex mode may transmit an uplink communication and receive a downlink communication at the same time (for example, in the same slot or the same symbol). “HD communication” in a wireless network refers to unidirectional communications (for example, only downlink communication or only uplink communication) between devices at a given time (for example, in a given slot or a given symbol).

As shown in FIG. 6, examples 600 and 605 show examples of in-band full-duplex (IBFD) communication. In IBFD, a UE (such as UE 120 or UE 304) may transmit an uplink communication to a network entity (and receive a downlink communication from the base station on the same time and frequency resources. As shown in example 600, in a first example of IBFD, the time and frequency resources for uplink communication may fully overlap with the time and frequency resources for downlink communication. As shown in example 605, in a second example of IBFD, the time and frequency resources for uplink communication may partially overlap with the time and frequency resources for downlink communication.

As further shown in FIG. 6, example 610 shows an example of SBFD communication, which may also be referred to as “sub-band frequency division duplex (SBFDD)” or “flexible duplex. ” In SBFD, a UE may transmit an uplink communication to a base station and receive a downlink communication from the base station at the same time, but on different frequency resources. For example, the different frequency resources may be sub-bands of a frequency band, such as a time division duplexing (TDD) band. In this case, the frequency resources used for downlink communication may be separated from the frequency resources used for uplink communication, in the frequency domain, by a guard band.

SBFD may increase an uplink duty cycle, improve uplink coverage, and reduce latency, because it is possible to transmit an uplink signal in an uplink sub-band in downlink only or in flexible slots. SBFD may enhance system capacity, resource utilization, and spectrum efficiency. SBFD may enable flexible and dynamic uplink and downlink resource adaption according to uplink and downlink traffic in a robust manner.

As indicated above, FIG. 6 is provided as an example. Other examples may differ from what is described with respect to FIG. 6.

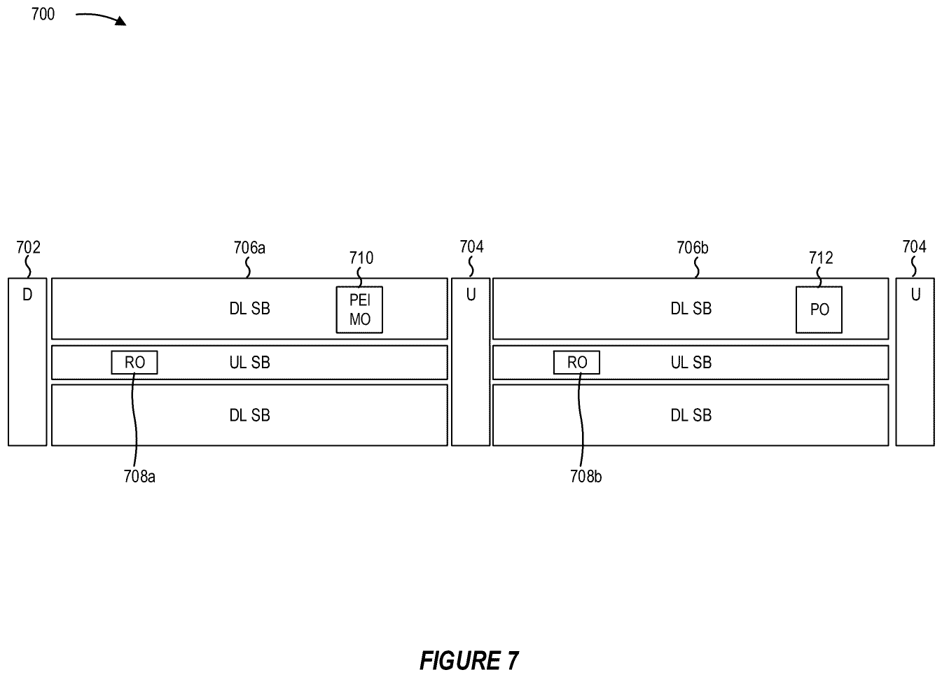

FIG. 7 is a diagram illustrating an example 700 of random access in SBFD symbols.

Example 700 shows a downlink resource 702, uplink resources 704, and SBFD resources 706 and 706b. As shown, PRACH occasions 708a and 708b (shown as “RO” as an acronym of “RACH occasion”) are configured in an uplink SB of SBFD resources 706a and 706b. In some examples, SBFD resource 706 is a slot. For example, SBFD resource 706 may include one or more symbols (for example, orthogonal frequency division multiplexing (OFDM) symbols) configured for SBFD communication.

As shown, a PEI MO 710 is configured in a downlink SB of SBFD resource 706a. A PEI MO 710 is a resource (such as a time and/or frequency resource) on which a UE may monitor for a PEI. A PEI is a signal that indicates whether a corresponding paging MO (such as paging MO 712) will be used for paging. As shown, a paging MO 712 (shown as “PO”) is configured in a downlink SB of SBFD resource 706b. In some aspects, the paging MO 712 may be associated with the PEI MO 710. For example, a PEI in the PEI MO 710 may indicate whether a UE should monitor the paging MO 712.

As mentioned, some UEs may not support bidirectional communication in an SBFD resource 706. For such a UE, it may be problematic to be configured with PRACH occasion 708a (which is for uplink communication) and PEI MO 710 (which is for downlink communication) in the same SBFD resource 706a. Similarly, it may be problematic to be configured with PRACH occasion 708b and paging MO 712 (which is for downlink communication) in the same SBFD resource 706b. This may be particularly problematic if PRACH occasion 708a overlaps or is close to PEI MO 710 in time, or if PRACH occasion 708b overlaps or is close to paging MO 712 in time.

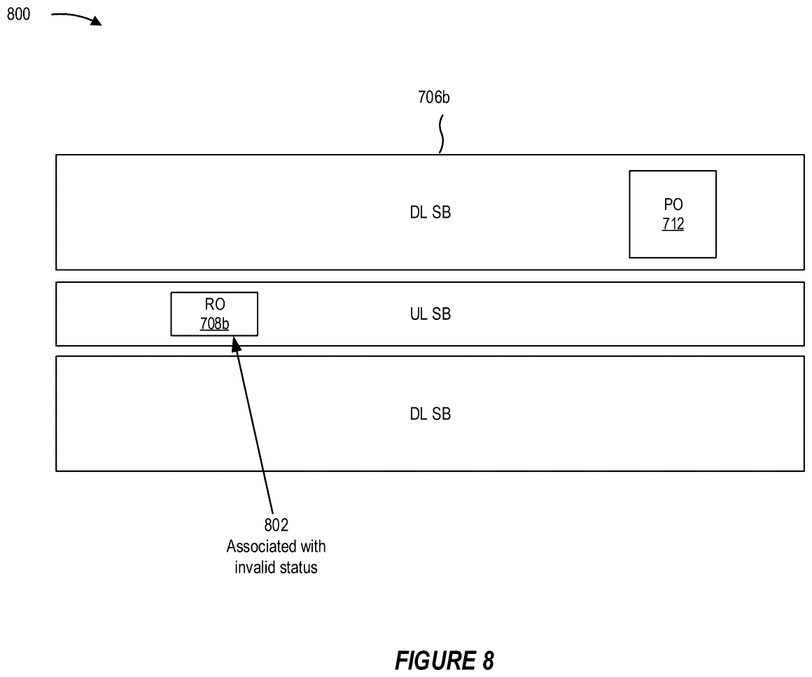

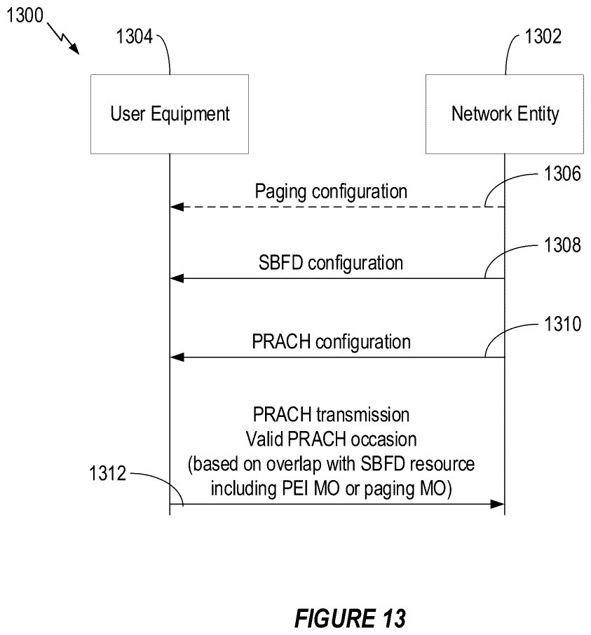

Aspects described herein provide determination of whether a PRACH occasion 708 is associated with a valid status. In some examples, this determination may be based on whether the PRACH occasion 708a overlaps (for example, is included in, is at least partially included in) an SBFD resource 706a that includes a PEI MO 710. In some examples, this determination may be based on whether the PRACH occasion 708b overlaps an SBFD resource 706b that includes a paging MO 712. FIGS. 8-12 provide examples of the determination of the valid status. FIG. 13 provides a description of signaling related to the configuration of SBFD, paging, and determination of the valid status.

As indicated above, FIG. 7 is provided as an example. Other examples may differ from what is described with regard to FIG. 7.

FIG. 8 is a diagram illustrating a first example 800 of a validity status for a PRACH occasion 708b that is overlapped by an SBFD resource 706b that includes a paging MO 712. In example 800, the SBFD resource 706b may be an SBFD slot.

As shown at 802, the PRACH occasion 708b may be associated with an invalid status. For example, the PRACH occasion 708b may be associated with the invalid status in accordance with the PRACH occasion 708b being overlapped by the SBFD resource 706b that includes the paging MO 712. Thus, a UE may consider the PRACH occasion 708b to be invalid if the PRACH occasion 708b falls within an SBFD slot (SBFD resource 706b) that has a paging MO 712. Based on the PRACH occasion 708b being associated with the invalid status, a UE may not perform a PRACH transmission on the PRACH occasion 708b, and/or may not map an SSB to the PRACH occasion 708b. SSB mapping is described in more detail in connection with FIG. 5.

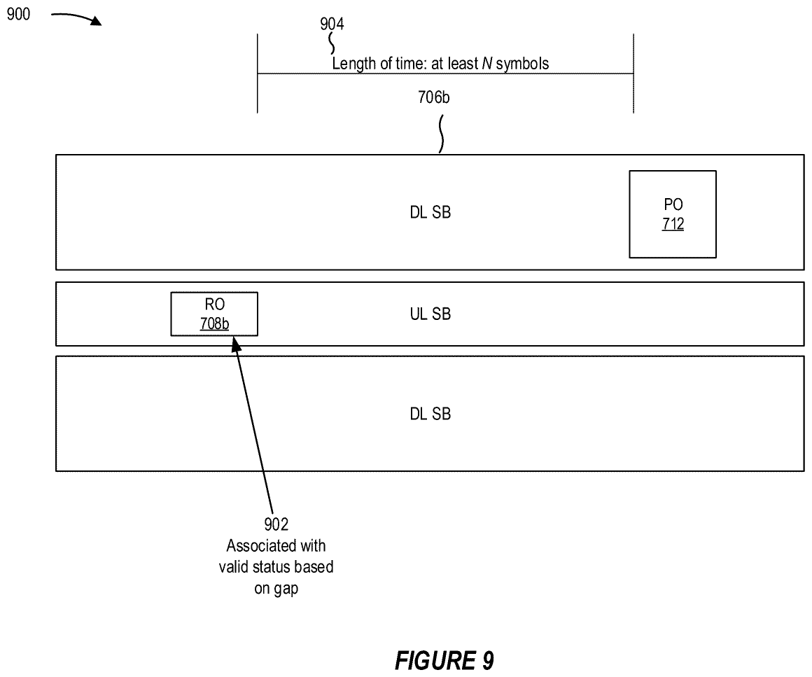

FIG. 9 is a diagram illustrating a second example 900 of a validity status for a PRACH occasion 708b that is overlapped by an SBFD resource 706b that includes a paging MO 712. In example 900, the SBFD resource 706b may be an SBFD slot.

As shown at 902, the PRACH occasion 708b may be associated with a valid status in example 900. For example, the PRACH occasion 708b may be associated with the valid status in accordance with the PRACH occasion 708b being overlapped by the SBFD resource 706b that includes the paging MO 712, and in accordance with the PRACH occasion being separated from the paging MO 712 by at least a length of time 904. For example, the length of time 904 may be defined as N symbols (for example, OFDM symbols), where N is an integer. Thus, a UE may consider the PRACH occasion 708b to be valid if the PRACH occasion 708b falls within an SBFD slot (SBFD resource 706b) that has a paging MO 712 only if there is a gap of N symbols (length of time 904) between the PRACH occasion 708b and the paging MO 712 (and the PRACH occasion 708b is in an uplink sub-band of the SBFD slot). Based on the PRACH occasion 708b being associated with the valid status, a UE may perform a PRACH transmission on the PRACH occasion 708b, and may map an SSB to the PRACH occasion 708b.

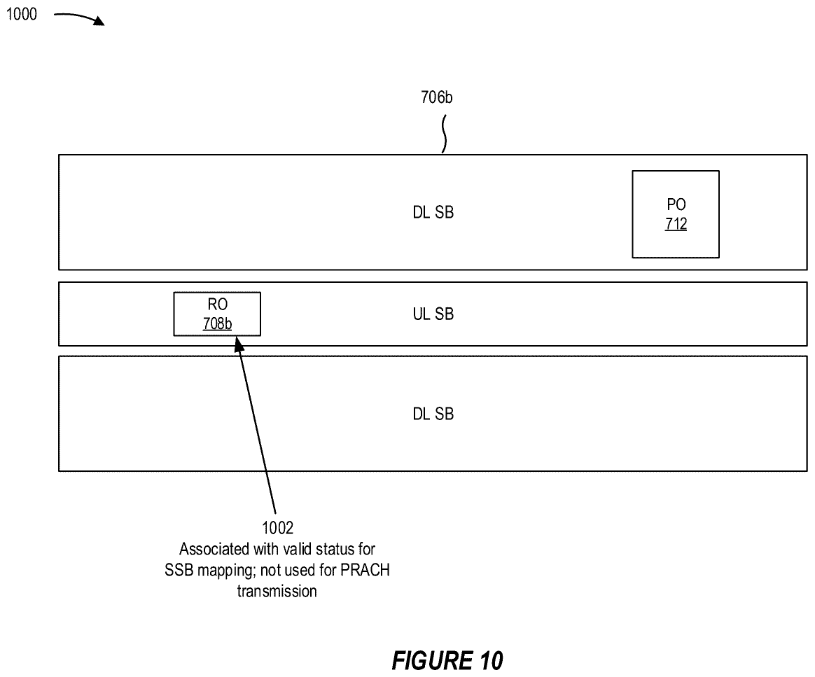

FIG. 10 is a diagram illustrating a third example 1000 of a validity status for a PRACH occasion 708b that is overlapped by an SBFD resource 706b that includes a paging MO 712. In example 1000, the SBFD resource 706b may be an SBFD slot.

As shown at 1002, the PRACH occasion 708b may be associated with a valid status for SSB mapping. For example, the PRACH occasion 708b may be associated with the valid status for SSB mapping in accordance with the PRACH occasion 708b being overlapped by the SBFD resource 706b that includes the paging MO 712. Thus, a UE may consider the PRACH occasion 708b to be valid for SSB mapping irrespective of whether the PRACH occasion 708b falls within an SBFD slot (SBFD resource 706b) that has a paging MO 712, and may not use the PRACH occasion 708b (such as for PRACH transmission) when the PRACH occasion 708b falls within an SBFD slot that has a paging MO 712. In some aspects, the valid status for SSB mapping may be further based on the PRACH occasion 708b being in an uplink sub-band of the SBFD resource 706b. Based on the PRACH occasion 708b being associated with the valid status for SSB mapping, a UE may not perform a PRACH transmission on the PRACH occasion 708b, and may map an SSB to the PRACH occasion 708b.

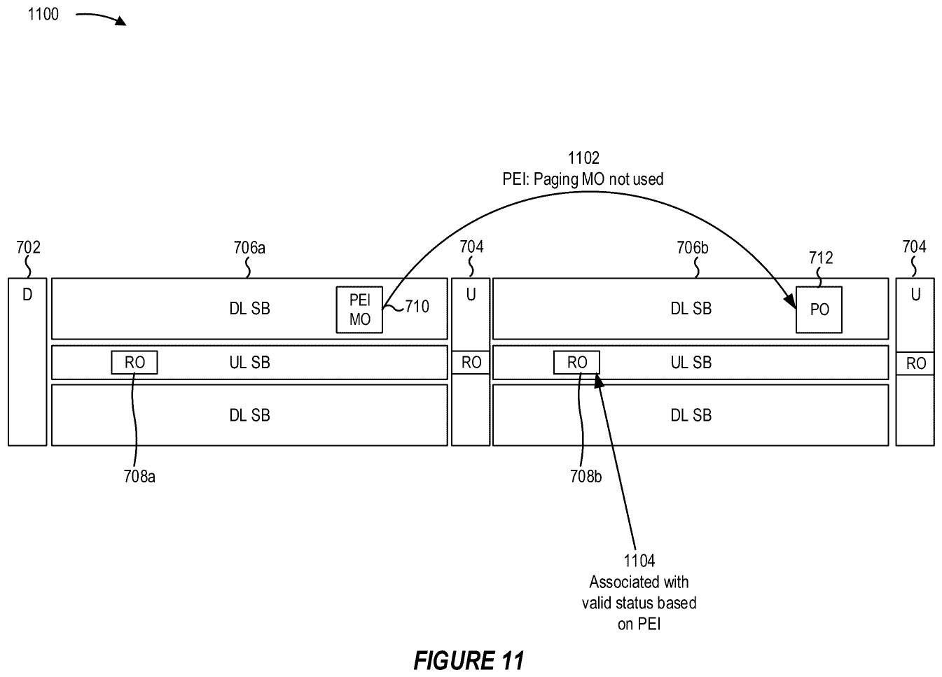

FIG. 11 is a diagram illustrating a fourth example 1100 of a validity status for a PRACH occasion 708b that is overlapped by an SBFD resource 706b that includes a paging MO 712. In example 1100, the SBFD resource 706b may be an SBFD slot.

As shown at 1102, in example 1100, a PEI (received on the PEI MO 710) may indicate that the paging MO 712 will not be used. For example, a UE may monitor the PEI MO 710, and may receive the PEI, which may provide an indication that the paging MO 712 will not be used. Thus, the UE may not need to monitor the paging MO 712, so the UE is free to use the PRACH occasion 708b that is overlapped by the SBFD resource 706b that includes the paging MO 712.

As shown at 1104, the PRACH occasion 708b may be associated with a valid status. For example, the PRACH occasion 708b may be associated with the valid status in accordance with the PRACH occasion 708b being overlapped by the SBFD resource 706b that includes the paging MO 712 and the paging MO 712 being indicated as being unused. Thus, a UE may consider the PRACH occasion 708b to be valid if the PRACH occasion 708b falls within an SBFD slot (SBFD resource 706b) that has a paging MO 712 and the UE is aware that the network will not send a paging indication in this paging MO (which can be determined via the PEI). In some aspects, the valid status may be further based on the PRACH occasion 708b being in an uplink sub-band of the SBFD resource 706b. Based on the PRACH occasion 708b being associated with the valid status, the UE may perform a PRACH transmission on the PRACH occasion 708b, and/or may map an SSB to the PRACH occasion 708b.

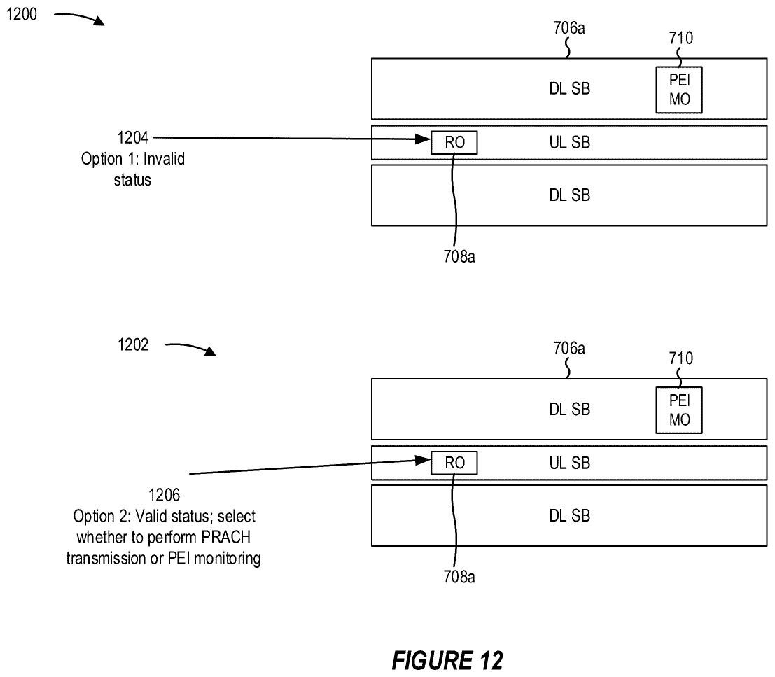

FIG. 12 is a diagram illustrating examples 1200 and 1202 of validity statuses for a PRACH occasion 708a that is overlapped by an SBFD resource 706a that includes a PEI MO 710. In examples 1200 and 1202, the SBFD resource 706b may be an SBFD slot.

In example 1200, as shown at 1206, the PRACH occasion 708a may be associated with an invalid status. For example, the PRACH occasion 708a may be associated with the invalid status in accordance with the PRACH occasion 708a being overlapped by the SBFD resource 706a that includes the PEI MO 710. Thus, a UE may consider the PRACH occasion 708a to be invalid if the PRACH occasion 708a falls within an SBFD slot (SBFD resource 706a) that has a PEI MO 710. Based on the PRACH occasion 708a being associated with the invalid status, a UE may not perform a PRACH transmission on the PRACH occasion 708a, and/or may not map an SSB to the PRACH occasion 708a.

Example 1202 differs from example 1200 at least because, in example 1202, the PRACH occasion 708a is associated with a valid status, as shown at 1208. In example 1202, at 1206, a UE may select between using the PRACH occasion 708a (for example, performing a PRACH transmission on the PRACH occasion 708a) or monitoring the PEI MO 710. In some examples, monitoring a PEI MO 710 may be optional, irrespective of whether the PEI MO 710 is included in an SBFD resource 706a that overlaps a PRACH occasion 708a. In some aspects, the valid status may be further based on the PRACH occasion 708a being in an uplink sub-band of the SBFD resource 706a.

FIG. 13 is a diagram illustrating an example 1300 of signaling for determination of a validity status for a PRACH occasion that is overlapped by an SBFD resource that includes a PEI MO or a paging MO. Example 1300 includes a network entity 1302 and a UE 1304. The network entity 1302 may be an example of network entity 110, network entity 300, network entity 302, network entity 402, or an element of a disaggregated network entity described with respect to FIG. 2. The UE 1304 may be an example of UE 120, UE 304, or UE 404.

In an operation 1306, the network entity 1302 optionally sends, and the UE 1304 optionally receives, a paging configuration. In some aspects, the paging configuration may indicate a location of one or more PEI MOs (such as PEI MO 710). Additionally, or alternatively, the paging configuration may indicate a location of one or more paging MOs (such as paging MO 712). In some aspects, the network entity 1302 may send the paging configuration via system information or RRC signaling.

In an operation 1308, the network entity 1302 sends, and the UE 1304 receives, an SBFD configuration. The SBFD configuration may indicate one or more SBFD resources (such as SBFD resources 706a and 706b). For example, the SBFD configuration may indicate that a slot is configured as an SBFD slot. In some aspects, the UE 1304 may be an SBFD-aware UE, and may be capable of processing the SBFD configuration. Thus, the UE 1304 may identify SBFD resources, and may determine validity of PRACH occasions included in the SBFD resources, as described with regard to FIGS. 8-12.

An SBFD resource configured by the SBFD configuration may include at least one of a paging MO or a PEI MO. For example, the SBFD resource may at least partially include the paging MO. As another example, the SBFD resource may at least partially include the PEI MO. The paging MO and/or the PEI MO may be configured by the paging configuration described with respect to the operation 1306.

In an operation 1310, the network entity 1302 sends, and the UE 1304 receives, a PRACH configuration. The PRACH configuration may indicate a set of PRACH occasions (such as ROs 504 or PRACH occasion 708). One or more PRACH occasions, of the set of PRACH occasions, may occur in an SBFD resource configured in connection with the operation 1308, and this SBFD resource may include one or more of the paging MO or the PEI MO. Aspects described herein provide determination of whether the one or more PRACH occasions are associated with a valid status, which may dictate whether the UE 1304 can perform a PRACH transmission on the one or more PRACH occasions or should select a different PRACH occasion for the PRACH transmission.

In an operation 1312, the UE 1304 performs a PRACH transmission on a PRACH occasion, of the set of PRACH occasions, that is associated with a valid status. The network entity 1302 may obtain (for example, receive) the PRACH transmission on the PRACH occasion that is associated with the valid status. In some aspects, the UE 1304 may select the PRACH occasion in accordance with the PRACH occasion having the valid status and in accordance with having received an SSB that is mapped to the PRACH occasion.

In some aspects, the PRACH occasion on which the PRACH transmission is performed is one of the one or more PRACH occasions that are overlapped by the SBFD resource that includes the paging MO or the PEI MO. For example, the one or more PRACH occasions may be associated with a valid status. Examples of PRACH occasions with valid statuses when overlapped by an SBFD resource that includes a PEI MO or a paging MO are described above with respect to FIG. 9 (at 902), FIG. 11 (at 1104), and FIG. 12 (at 1206).

In some aspects, the one or more PRACH occasions are associated with the valid status only for SSB mapping, so the UE 1304 may transmit the PRACH transmission on a PRACH occasion that is not one of the one or more PRACH occasions. The PRACH occasion on which the UE 1304 transmits the PRACH transmission may be associated with the valid status for SSB mapping and for PRACH transmission. An example of a PRACH occasion with a valid status for SSB mapping is provided in connection with FIG. 10 (at 1002).

In some aspects, the one or more PRACH occasions are associated with an invalid status. For example, the one or more PRACH occasions may be associated with the invalid status based on the one or more PRACH occasions being overlapped by an SBFD resource that includes a paging MO or a PEI MO. Examples of such PRACH occasions are provided in connection with FIG. 8 (at 802) and FIG. 12 (at 1204). In this case, the PRACH occasion on which the PRACH transmission is performed may be associated with a valid status and may not be one of the one or more PRACH transmissions.

FIG. 14 shows a process 1400 for wireless communications by an apparatus, such as UE 120 of FIG. 1 or UE 304 of FIG. 3.

Process 1400 begins at block 1405 with receiving a SBFD configuration (as described at 1308) that indicates an SBFD resource, wherein the SBFD resource includes at least one of a paging monitoring occasion or a paging early indication monitoring occasion.

Process 1400 then proceeds to block 1410 with receiving a PRACH configuration (as described at 1310) that indicates a set of PRACH occasions, wherein one or more PRACH occasions of the set of PRACH occasions occur in the SBFD resource.

Process 1400 then proceeds to block 1415 with performing a PRACH transmission (as described at 1312) on a PRACH occasion, of the set of PRACH occasions, that is associated with a valid status, wherein the valid status is associated with one or more of: whether the PRACH occasion is overlapped by the SBFD resource and the SBFD resource includes the paging monitoring occasion, or whether the PRACH occasion is overlapped by the SBFD resource and the SBFD resource includes the paging early indication monitoring occasion.

In some aspects, the one or more PRACH occasions are associated with an invalid status in accordance with the one or more PRACH occasions being overlapped by the SBFD resource.

In some aspects, the PRACH occasion is associated with the valid status in accordance with the PRACH occasion being non-overlapped by the SBFD resource and the PRACH occasion being included in an uplink sub-band of the SBFD resource.

In some aspects, the PRACH occasion is associated with the valid status in accordance with: the PRACH occasion being overlapped by the SBFD resource, the PRACH occasion being separated from the paging monitoring occasion by a length of time, and the PRACH occasion being included in an uplink sub-band of the SBFD resource.

In some aspects, another PRACH occasion, of the set of PRACH occasions, is associated with the valid status in accordance with the other PRACH occasion being non-overlapped with the SBFD resource including the paging monitoring occasion.

In some aspects, the other PRACH occasion is associated with the valid status for synchronization signal block mapping.

In some aspects, process 1400 further includes receiving an indication that the paging monitoring occasion is unused, wherein the PRACH occasion is associated with the valid status in accordance with the paging monitoring occasion being unused.

In some aspects, the one or more PRACH occasions are associated with an invalid status in accordance with the one or more PRACH occasions being overlapped by the SBFD resource including the paging early indication monitoring occasion.

In some aspects, the PRACH occasion is associated with the valid status in accordance with the PRACH occasion being non-overlapped by the SBFD resource including the paging early indication monitoring occasion.

In some aspects, the one or more PRACH occasions, including the PRACH occasion, are associated with the valid status, and are overlapped by the SBFD resource including the paging early indication monitoring occasion, wherein the process 1400 further comprises monitoring for a paging early indication during the one or more PRACH occasions.

In some aspects, process 1400 further includes selecting, prior to performing the PRACH transmission, between performing the PRACH transmission or monitoring for a paging early indication during the paging early indication monitoring occasion.

In some aspects, the PRACH occasion is associated with the valid status in accordance with the PRACH occasion being overlapped by SBFD resource including the paging early indication monitoring occasion.

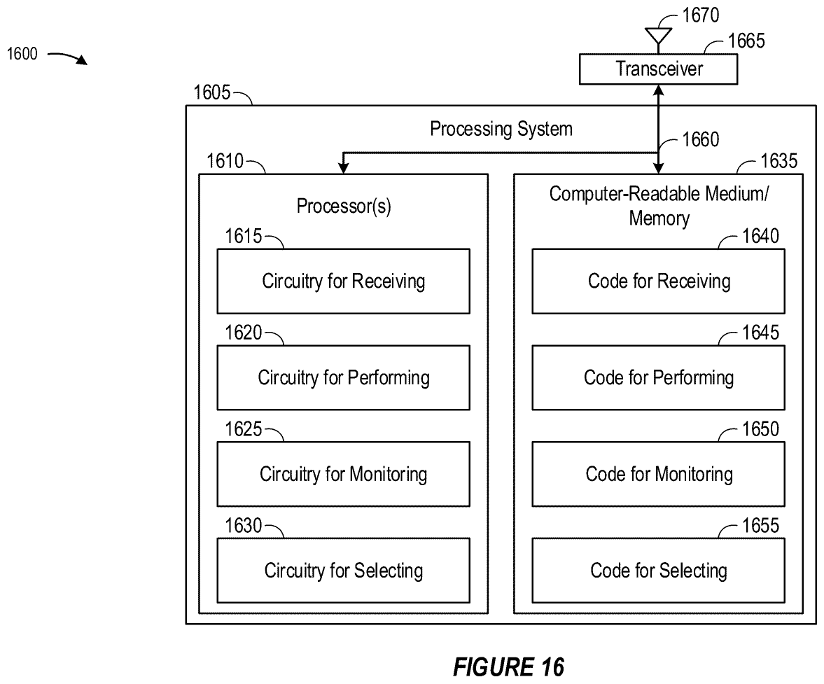

In some aspect, process 1400, or any aspect related to process 1400, may be performed by an apparatus, such as communications device 1600 of FIG. 16, which includes various components operable, configured, or adapted to perform the process 1400. Communications device 1600 is described below in further detail.

Note that FIG. 14 is just one example of a process, and other processes including fewer, additional, or alternative operations are possible consistent with this disclosure.

FIG. 15 shows a process 1500 for wireless communications by an apparatus, such as network entity 110 of FIG. 1, a first network entity 300 or second network entity 302 of FIG. 3, or a disaggregated base station as described with respect to FIG. 2.

Process 1500 begins at block 1505 with sending an SBFD configuration (as described at 1308) that indicates an SBFD resource, wherein the SBFD resource includes at least one of a paging monitoring occasion or a paging early indication monitoring occasion.

Process 1500 then proceeds to block 1510 with sending a PRACH configuration (as described at 1310) that indicates a set of PRACH occasions, wherein one or more PRACH occasions of the set of PRACH occasions occur in the SBFD resource.

Process 1500 then proceeds to block 1515 with receiving a PRACH transmission (as described at 1312) on a PRACH occasion, of the set of PRACH occasions, that is associated with a valid status, wherein the valid status is associated with one or more of: whether the PRACH occasion is overlapped by the SBFD resource including the paging monitoring occasion, or whether the PRACH occasion is overlapped by the SBFD resource including the paging early indication monitoring occasion. For example, the valid status may be derived from whether the PRACH occasion is overlapped by the SBFD resource including the paging monitoring occasion. As another example, the valid status may be derived from whether the PRACH occasion is overlapped by the SBFD resource including the paging early indication monitoring occasion.

In some aspects, the one or more PRACH occasions are associated with an invalid status in accordance with the one or more PRACH occasions being overlapped by the SBFD resource.

In some aspects, the PRACH occasion is associated with the valid status in accordance with the PRACH occasion being non-overlapped by the SBFD resource.

In some aspects, the PRACH occasion is associated with the valid status in accordance with: the PRACH occasion being overlapped by the SBFD resource, the PRACH occasion being separated from the paging monitoring occasion by a length of time, and the PRACH occasion being included in an uplink sub-band of the SBFD resource.

In some aspects, another PRACH occasion, of the set of PRACH occasions, is associated with the valid status in accordance with the other PRACH occasion being non-overlapped with the SBFD resource including the paging monitoring occasion.

In some aspects, the other PRACH occasion is associated with the valid status for synchronization signal block mapping.

In certain aspects, process 1500 further includes sending an indication that the paging monitoring occasion is unused, wherein the PRACH occasion is associated with the valid status in accordance with the paging monitoring occasion being unused.

In some aspects, the one or more PRACH occasions are associated with an invalid status in accordance with the one or more PRACH occasions being overlapped by the SBFD resource including the paging early indication monitoring occasion.

In some aspects, the PRACH occasion is associated with the valid status in accordance with the PRACH occasion being non-overlapped by the SBFD resource including the paging early indication monitoring occasion.

In some aspects, the one or more PRACH occasions include the PRACH occasion, are associated with the valid status, and are overlapped by the SBFD resource including the paging early indication monitoring occasion, wherein the process 1500 further comprises sending a paging early indication during the one or more PRACH occasions.

In some aspects, the PRACH occasion is associated with the valid status in accordance with the PRACH occasion being overlapped by SBFD resource including the paging early indication monitoring occasion.

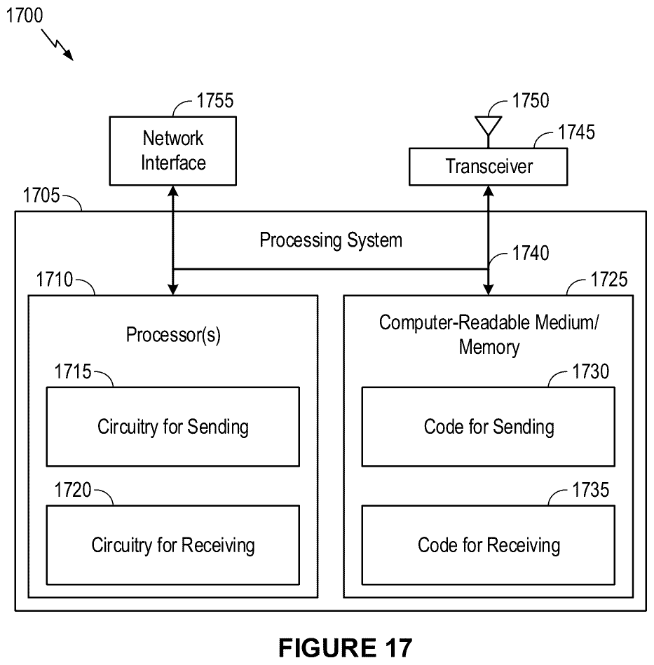

In some aspect, process 1500, or any aspect related to it, may be performed by an apparatus, such as communications device 1700 of FIG. 17, which includes various components operable, configured, or adapted to perform the process 1500. Communications device 1700 is described below in further detail.

Note that FIG. 15 is just one example of a process, and other processes including fewer, additional, or alternative operations are possible consistent with this disclosure.

### Example Communications Devices

FIG. 16 depicts aspects of an example communications device 1600 configured for wireless communications. In some aspects, communications device 1600 is a user equipment, such as UE 120 described above with respect to FIG. 1 or UE 304 described with respect to FIG. 3.

The communications device 1600 includes a processing system 1605 coupled to a transceiver 1665 (for example, a transmitter and/or a receiver). The transceiver 1665 is configured to transmit and receive signals for the communications device 1600 via an antenna 1670, such as the various signals as described herein. The processing system 1605 may be configured to perform processing functions for the communications device 1600, including processing signals received and/or to be transmitted by the communications device 1600.

The processing system 1605 includes one or more processors 1610 and a computer-readable medium/memory 1635. In various aspects, the one or more processors 1610 may be representative of the one or more processors 318 described with respect to FIG. 3. The one or more processors 1610 are coupled to a computer-readable medium/memory 1635 via a bus 1660. In some aspects, the computer-readable medium/memory 1635 may be representative of the one or more memories 320 described with respect to FIG. 3. The computer-readable medium/memory 1635 is a non-transitory computer-readable medium/memory. In certain aspects, the computer-readable medium/memory 1635 is configured to store instructions (for example, computer-executable code), that when executed by the one or more processors 1610, cause the one or more processors 1610 to perform the process 1400 described with respect to FIG. 14, or any aspect related to the process 1400, including any operations described in relation to FIG. 14. Note that reference to a processor performing a function of communications device 1600 may include one or more processors performing that function of communications device 1600, such as in a distributed fashion.

In the depicted example, computer-readable medium/memory 1635 stores code (for example, executable instructions), including code for receiving 1640, code for performing 1645, code for monitoring 1650, and code for selecting 1655. Processing of the code 1640-1655 may enable and cause the communications device 1600 to perform the process 1400 described with respect to FIG. 14, or any aspect related to the process 1400.

The one or more processors 1610 include circuitry configured to implement (for example, execute) the code stored in the computer-readable medium/memory 1635, including circuitry for receiving 1615, circuitry for performing 1620, circuitry for monitoring 1625, and circuitry for selecting 1630. Processing with circuitry 1615-1630 may enable and cause the communications device 1600 to perform the process 1400 described with respect to FIG. 14, or any aspect related to the process 1400.

More generally, means for communicating, transmitting, sending or outputting for transmission may include the one or more transceivers 324, one or more antennas 322 and/or processing system 316 of the UE 304 illustrated in FIG. 3, transceiver 1665 and/or antenna 1670 of the communications device 1600 in FIG. 16, and/or one or more processors 1610 of the communications device 1600 in FIG. 16. Means for communicating, receiving or obtaining may include the one or more transceivers 324, one or more antennas 322, and/or processing system 316 of the UE 304 illustrated in FIG. 3, transceiver 1665 and/or antenna 1670 of the communications device 1600 in FIG. 16, and/or one or more processors 1610 of the communications device 1600 in FIG. 16.

In some aspects, the processing system 316 may include means for receiving an SBFD configuration that indicates an SBFD resource; means for receiving a PRACH configuration that indicates a set of PRACH occasions; and means for performing a PRACH transmission on a PRACH occasion. In some aspects, these means may include the means for communicating, transmitting, sending, outputting, receiving, or obtaining described herein.

FIG. 17 depicts aspects of an example communications device 1700 configured for wireless communications. In some aspects, communications device 1700 is a network entity, such as network entity 110 of FIG. 1, first network entity 300 or second network entity 302 of FIG. 3, or a disaggregated base station as discussed with respect to FIG. 2.

The communications device 1700 includes a processing system 1705 coupled to a transceiver 1745 (for example, a transmitter and/or a receiver) and/or a network interface 1755. The transceiver 1745 is configured to transmit and receive signals for the communications device 1700 via an antenna 1750, such as the various signals as described herein. The network interface 1755 is configured to obtain and send signals for the communications device 1700 via communications link(s), such as a backhaul link, midhaul link, and/or fronthaul link as described herein, such as with respect to FIG. 2. The processing system 1705 may be configured to perform processing functions for the communications device 1700, including processing signals received and/or to be transmitted by the communications device 1700.

The processing system 1705 includes one or more processors 1710 and a computer-readable medium/memory 1725. In various aspects, one or more processors 1710 may be representative of the one or more processors 308, as described with respect to FIG. 3. The one or more processors 1710 are coupled to the computer-readable medium/memory 1725 via a bus 1740. In certain aspects, the computer-readable medium/memory 1725 is configured to store instructions (for example, computer-executable code), including code 1730 and 1735, that when executed by the one or more processors 1710, cause the one or more processors 1710 to perform the process 1500 described with respect to FIG. 15, or any aspect related to the process 1500, including any operations described in relation to FIG. 15. The computer-readable medium/memory 1725 is a non-transitory computer-readable medium/memory. Note that reference to a processor of communications device 1700 performing a function may include one or more processors of communications device 1700 performing that function, such as in a distributed fashion.

In the depicted example, the computer-readable medium/memory 1725 stores code (for example, executable instructions), including code for sending 1730 and code for receiving 1735. Processing of the code 1730 and 1735 may enable and cause the communications device 1700 to perform the process 1500 described with respect to FIG. 15, or any aspect related to the process 1500.

The one or more processors 1710 include circuitry configured to implement (for example, execute) the code stored in the computer-readable medium/memory 1725, including circuitry for sending 1715 and circuitry for receiving 1720. Processing with circuitry 1715 and 1720 may enable and cause the communications device 1700 to perform the process 1500 described with respect to FIG. 15, or any aspect related to the process 1500.

Various components of the communications device 1700 may provide means for performing the process 1500 described with respect to FIG. 15, or any aspect related to the process 1500. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1745, antenna 1750, and/or network interface 1755 of the communications device 1700 in FIG. 17, and/or one or more processors 1710 of the communications device 1700 in FIG. 17. Means for communicating, receiving or obtaining may include the one or more transceivers 312, one or more antennas 314, and/or processing system 306 of the first network entity 300 or the second network entity 302 illustrated in FIG. 3, transceiver 1745, antenna 1750, and/or network interface 1755 of the communications device 1700 in FIG. 17, and/or one or more processors 1710 of the communications device 1700 in FIG. 17.

In some aspects, the communications device 1700 may include means for sending an SBFD configuration that indicates an SBFD resource; means for sending a PRACH configuration that indicates a set of PRACH occasions; and means for receiving a PRACH transmission on a PRACH occasion, of the set of PRACH occasions. Such means may include the means for communicating, transmitting, sending, outputting, receiving, or obtaining described herein.

### Example Clauses

Implementation examples are described in the following numbered clauses:

Clause 1: A method for wireless communications by an apparatus comprising: receiving a SBFD configuration that indicates an SBFD resource, wherein the SBFD resource includes at least one of a paging monitoring occasion or a paging early indication monitoring occasion; receiving a PRACH configuration that indicates a set of PRACH occasions, wherein one or more PRACH occasions of the set of PRACH occasions occur in the SBFD resource; and performing a PRACH transmission on a PRACH occasion, of the set of PRACH occasions, that is associated with a valid status, wherein the valid status is associated with one or more of: whether the PRACH occasion is overlapped by the SBFD resource and the SBFD resource includes the paging monitoring occasion, or whether the PRACH occasion is overlapped by the SBFD resource and the SBFD resource includes the paging early indication monitoring occasion.

Clause 2: The method of Clause 1, wherein the one or more PRACH occasions are associated with an invalid status in accordance with the one or more PRACH occasions being overlapped by the SBFD resource.

Clause 3: The method of any one of Clauses 1-2, wherein the PRACH occasion is associated with the valid status in accordance with the PRACH occasion being non-overlapped by the SBFD resource and the PRACH occasion being included in an uplink sub-band of the SBFD resource.

Clause 4: The method of any one of Clauses 1-3, wherein the PRACH occasion is associated with the valid status in accordance with: the PRACH occasion being overlapped by the SBFD resource, the PRACH occasion being separated from the paging monitoring occasion by a length of time, and the PRACH occasion being included in an uplink sub-band of the SBFD resource.

Clause 5: The method of any one of Clauses 1-4, wherein another PRACH occasion, of the set of PRACH occasions, is associated with the valid status in accordance with the other PRACH occasion being non-overlapped with the SBFD resource including the paging monitoring occasion.

Clause 6: The method of Clause 5, wherein the other PRACH occasion is associated with the valid status for synchronization signal block mapping.

Clause 7: The method of any one of Clauses 1-6, further comprising receiving an indication that the paging monitoring occasion is unused, wherein the PRACH occasion is associated with the valid status in accordance with the paging monitoring occasion being unused.

Clause 8: The method of any one of Clauses 1-7, wherein the one or more PRACH occasions are associated with an invalid status in accordance with the one or more PRACH occasions being overlapped by the SBFD resource including the paging early indication monitoring occasion.

Clause 9: The method of any one of Clauses 1-8, wherein the PRACH occasion is associated with the valid status in accordance with the PRACH occasion being non-overlapped by the SBFD resource including the paging early indication monitoring occasion.

Clause 10: The method of any one of Clauses 1-9, wherein the one or more PRACH occasions, including the PRACH occasion, are associated with the valid status, and are overlapped by the SBFD resource including the paging early indication monitoring occasion, wherein the method further comprises monitoring for a paging early indication during the one or more PRACH occasions.

Clause 12: The method of Clause 10, further comprising selecting, prior to performing the PRACH transmission, between performing the PRACH transmission or monitoring for a paging early indication during the paging early indication monitoring occasion.

Clause 11: The method of any one of Clauses 1-10, wherein the PRACH occasion is associated with the valid status in accordance with the PRACH occasion being overlapped by SBFD resource including the paging early indication monitoring occasion.

Clause 13: A method for wireless communications by an apparatus comprising: sending a SBFD configuration that indicates an SBFD resource, wherein the SBFD resource includes at least one of a paging monitoring occasion or a paging early indication monitoring occasion; sending a PRACH configuration that indicates a set of PRACH occasions, wherein one or more PRACH occasions of the set of PRACH occasions occur in the SBFD resource; and receiving a PRACH transmission on a PRACH occasion, of the set of PRACH occasions, that is associated with a valid status, wherein the valid status is associated with one or more of: whether the PRACH occasion is overlapped by the SBFD resource including the paging monitoring occasion, or whether the PRACH occasion is overlapped by the SBFD resource including the paging early indication monitoring occasion.

Clause 14: The method of Clause 13, wherein the one or more PRACH occasions are associated with an invalid status in accordance with the one or more PRACH occasions being overlapped by the SBFD resource.

Clause 15: The method of any one of Clauses 13-14, wherein the PRACH occasion is associated with the valid status in accordance with the PRACH occasion being non-overlapped by the SBFD resource.

Clause 16: The method of any one of Clauses 13-15, wherein the PRACH occasion is associated with the valid status in accordance with: the PRACH occasion being overlapped by the SBFD resource, the PRACH occasion being separated from the paging monitoring occasion by a length of time, and the PRACH occasion being included in an uplink sub-band of the SBFD resource.

Clause 17: The method of any one of Clauses 13-16, wherein another PRACH occasion, of the set of PRACH occasions, is associated with the valid status in accordance with the other PRACH occasion being non-overlapped with the SBFD resource including the paging monitoring occasion.

Clause 18: The method of Clause 17, wherein the other PRACH occasion is associated with the valid status for synchronization signal block mapping.

Clause 19: The method of any one of Clauses 13-18, further comprising sending an indication that the paging monitoring occasion is unused, wherein the PRACH occasion is associated with the valid status in accordance with the paging monitoring occasion being unused.

Clause 20: The method of any one of Clauses 13-19, wherein the one or more PRACH occasions are associated with an invalid status in accordance with the one or more PRACH occasions being overlapped by the SBFD resource including the paging early indication monitoring occasion.

Clause 21: The method of any one of Clauses 13-20, wherein the PRACH occasion is associated with the valid status in accordance with the PRACH occasion being non-overlapped by the SBFD resource including the paging early indication monitoring occasion.

Clause 22: The method of any one of Clauses 13-21, wherein the one or more PRACH occasions include the PRACH occasion, are associated with the valid status, and are overlapped by the SBFD resource including the paging early indication monitoring occasion, wherein the method further comprises sending a paging early indication during the one or more PRACH occasions.

Clause 23: The method of any one of Clauses 13-22, wherein the PRACH occasion is associated with the valid status in accordance with the PRACH occasion being overlapped by SBFD resource including the paging early indication monitoring occasion.

Clause 24: One or more apparatuses, comprising: one or more memories comprising executable instructions; and one or more processors configured to execute the executable instructions and cause the one or more apparatuses to perform a method in accordance with any one of Clauses 1-23.

Clause 25: One or more apparatuses configured for wireless communications, comprising: one or more memories; and one or more processors, coupled to the one or more memories, configured to cause the one or more apparatuses to perform a method in accordance with any one of Clauses 1-23.

Clause 26: One or more apparatuses configured for wireless communications, comprising: one or more memories; and one or more processors, coupled to the one or more memories, configured to perform a method in accordance with any one of Clauses 1-23.

Clause 27: One or more apparatuses, comprising means for performing a method in accordance with any one of Clauses 1-23.

Clause 28: One or more non-transitory computer-readable media comprising executable instructions that, when executed by one or more processors of one or more apparatuses, cause the one or more apparatuses to perform a method in accordance with any one of Clauses 1-23.

Clause 29: One or more computer program products embodied on one or more computer-readable storage media comprising code for performing a method in accordance with any one of Clauses 1-23.

Clause 30: One or more apparatuses configured for wireless communications, comprising: a processing system that includes one or more processors and one or more memories coupled with the one or more processors, the processing system configured to cause the one or more apparatuses to perform a method in accordance with any one of Clauses 1-23.

The foregoing disclosure provides illustration and description but is not intended to be exhaustive or to limit the aspects to the precise forms disclosed.

Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, the articles “a” and “an” are intended to refer to one or more items and may be used interchangeably with “one or more” or “at least one. ” Further, as used herein, the article “the” is intended to include one or more items referenced in connection with the article “the” and may be used interchangeably with “the one or more. ” Furthermore, as used herein, the terms “set” and “group” are intended to include one or more items and may be used interchangeably with “one or more. ” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a +a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus configured for wireless communication, comprising:
a processing system comprising one or more processors and one or more memories coupled to the one or more processors, wherein the processing system is configured to cause the apparatus to:
receive a sub-band full duplex (SBFD) configuration that indicates an SBFD resource, wherein the SBFD resource includes at least one of a paging monitoring occasion or a paging early indication monitoring occasion;
receive a physical random access channel (PRACH) configuration that indicates a set of PRACH occasions, wherein one or more PRACH occasions of the set of PRACH occasions occur in the SBFD resource; and
perform a PRACH transmission on a PRACH occasion, of the set of PRACH occasions, that is associated with a valid status, wherein the valid status is associated with one or more of:
whether the PRACH occasion is overlapped by the SBFD resource and the SBFD resource includes the paging monitoring occasion, or
whether the PRACH occasion is overlapped by the SBFD resource and the SBFD resource includes the paging early indication monitoring occasion.

2. The apparatus of claim 1, wherein the one or more PRACH occasions are associated with an invalid status in accordance with the one or more PRACH occasions being overlapped by the SBFD resource.

3. The apparatus of claim 1, wherein the PRACH occasion is associated with the valid status in accordance with the PRACH occasion being non-overlapped by the SBFD resource and the PRACH occasion being included in an uplink sub-band of the SBFD resource.

4. The apparatus of claim 1, wherein the PRACH occasion is associated with the valid status in accordance with: the PRACH occasion being overlapped by the SBFD resource, the PRACH occasion being separated from the paging monitoring occasion by a length of time, and the PRACH occasion being included in an uplink sub-band of the SBFD resource.

5. The apparatus of claim 1, wherein another PRACH occasion, of the set of PRACH occasions, is associated with the valid status in accordance with the other PRACH occasion being non-overlapped with the SBFD resource including the paging monitoring occasion.

6. The apparatus of claim 5, wherein the other PRACH occasion is associated with the valid status for synchronization signal block mapping.

7. The apparatus of claim 1, wherein the processing system is configured to cause the apparatus to receive an indication that the paging monitoring occasion is unused, wherein the PRACH occasion is associated with the valid status in accordance with the paging monitoring occasion being unused.

8. The apparatus of claim 1, wherein the one or more PRACH occasions are associated with an invalid status in accordance with the one or more PRACH occasions being overlapped by the SBFD resource including the paging early indication monitoring occasion.

9. The apparatus of claim 1, wherein the PRACH occasion is associated with the valid status in accordance with the PRACH occasion being non-overlapped by the SBFD resource including the paging early indication monitoring occasion.

10. The apparatus of claim 1, wherein the one or more PRACH occasions, including the PRACH occasion, are associated with the valid status, and are overlapped by the SBFD resource including the paging early indication monitoring occasion, wherein the processing system is configured to cause the apparatus to monitor for a paging early indication during the one or more PRACH occasions.

11. The apparatus of claim 1, wherein the PRACH occasion is associated with the valid status in accordance with the PRACH occasion being overlapped by SBFD resource including the paging early indication monitoring occasion.

12. The apparatus of claim 10, wherein the processing system is configured to cause the apparatus to select, prior to performing the PRACH transmission, between performing the PRACH transmission or monitoring for a paging early indication during the paging early indication monitoring occasion.

13. An apparatus for wireless communication, comprising:
a processing system comprising one or more processors and one or more memories coupled to the one or more processors, wherein the processing system is configured to cause the apparatus to:
send a sub-band full duplex (SBFD) configuration that indicates an SBFD resource, wherein the SBFD resource includes at least one of a paging monitoring occasion or a paging early indication monitoring occasion;
send a physical random access channel (PRACH) configuration that indicates a set of PRACH occasions, wherein one or more PRACH occasions of the set of PRACH occasions occur in the SBFD resource; and
receive a PRACH transmission on a PRACH occasion, of the set of PRACH occasions, that is associated with a valid status, wherein the valid status is associated with one or more of:
whether the PRACH occasion is overlapped by the SBFD resource including the paging monitoring occasion, or
whether the PRACH occasion is overlapped by the SBFD resource including the paging early indication monitoring occasion.

14. The apparatus of claim 13, wherein the one or more PRACH occasions are associated with an invalid status in accordance with the one or more PRACH occasions being overlapped by the SBFD resource.

15. The apparatus of claim 13, wherein the PRACH occasion is associated with the valid status in accordance with the PRACH occasion being non-overlapped by the SBFD resource.

16. The apparatus of claim 13, wherein the PRACH occasion is associated with the valid status in accordance with: the PRACH occasion being overlapped by the SBFD resource, the PRACH occasion being separated from the paging monitoring occasion by a length of time, and the PRACH occasion being included in an uplink sub-band of the SBFD resource.

17. The apparatus of claim 13, wherein another PRACH occasion, of the set of PRACH occasions, is associated with the valid status in accordance with the other PRACH occasion being non-overlapped with the SBFD resource including the paging monitoring occasion.

18. The apparatus of claim 17, wherein the other PRACH occasion is associated with the valid status for synchronization signal block mapping.

19. The apparatus of claim 13, wherein the processing system is configured to cause the apparatus to send an indication that the paging monitoring occasion is unused, wherein the PRACH occasion is associated with the valid status in accordance with the paging monitoring occasion being unused.

20. The apparatus of claim 13, wherein the one or more PRACH occasions are associated with an invalid status in accordance with the one or more PRACH occasions being overlapped by the SBFD resource including the paging early indication monitoring occasion.

21. The apparatus of claim 13, wherein the PRACH occasion is associated with the valid status in accordance with the PRACH occasion being non-overlapped by the SBFD resource including the paging early indication monitoring occasion.

22. The apparatus of claim 13, wherein the one or more PRACH occasions include the PRACH occasion, are associated with the valid status, and are overlapped by the SBFD resource including the paging early indication monitoring occasion, wherein the processing system is configured to cause the apparatus to send a paging early indication during the one or more PRACH occasions.

23. The apparatus of claim 13, wherein the PRACH occasion is associated with the valid status in accordance with the PRACH occasion being overlapped by SBFD resource including the paging early indication monitoring occasion.

24. A method for wireless communications by an apparatus comprising:
receiving a sub-band full duplex (SBFD) configuration that indicates an SBFD resource, wherein the SBFD resource includes at least one of a paging monitoring occasion or a paging early indication monitoring occasion;
receiving a physical random access channel (PRACH) configuration that indicates a set of PRACH occasions, wherein one or more PRACH occasions of the set of PRACH occasions occur in the SBFD resource; and
performing a PRACH transmission on a PRACH occasion, of the set of PRACH occasions, that is associated with a valid status, wherein the valid status is associated with one or more of:
whether the PRACH occasion is overlapped by the SBFD resource and the SBFD resource includes the paging monitoring occasion, or whether the PRACH occasion is overlapped by the SBFD resource and the SBFD resource includes the paging early indication monitoring occasion.

25. The method of claim 24, wherein the one or more PRACH occasions are associated with an invalid status in accordance with the one or more PRACH occasions being overlapped by the SBFD resource.

26. The method of claim 24, wherein the PRACH occasion is associated with the valid status in accordance with the PRACH occasion being non-overlapped by the SBFD resource and the PRACH occasion being included in an uplink sub-band of the SBFD resource.

27. The method of claim 24, wherein the PRACH occasion is associated with the valid status in accordance with: the PRACH occasion being overlapped by the SBFD resource, the PRACH occasion being separated from the paging monitoring occasion by a length of time, and the PRACH occasion being included in an uplink sub-band of the SBFD resource.

28. A method for wireless communications by an apparatus comprising:
sending a sub-band full duplex (SBFD) configuration that indicates an SBFD resource, wherein the SBFD resource includes at least one of a paging monitoring occasion or a paging early indication monitoring occasion;
sending a physical random access channel (PRACH) configuration that indicates a set of PRACH occasions, wherein one or more PRACH occasions of the set of PRACH occasions occur in the SBFD resource; and
receiving a PRACH transmission on a PRACH occasion, of the set of PRACH occasions, that is associated with a valid status, wherein the valid status is associated with one or more of:
whether the PRACH occasion is overlapped by the SBFD resource including the paging monitoring occasion, or
whether the PRACH occasion is overlapped by the SBFD resource including the paging early indication monitoring occasion.

29. The method of claim 28, wherein the one or more PRACH occasions are associated with an invalid status in accordance with the one or more PRACH occasions being overlapped by the SBFD resource.

30. The method of claim 28, wherein the PRACH occasion is associated with the valid status in accordance with the PRACH occasion being non-overlapped by the SBFD resource.
